(19) United States
(12) Patent Application Publication
(10) Pub. No.: US 2025/0139040 A1
(43) Pub. Date: May 1, 2025

(54) STATEFUL FLOW TABLE MANAGEMENT USING PROGRAMMABLE NETWORK INTERFACE DEVICES

(71) Applicant: Intel Corporation, Santa Clara, CA (US)

(72) Inventors: Anjali Singhai Jain, Portland, OR (US); Naren Mididaddi, San Ramon, CA (US); Arunkumar Balakrishnan, Santa Clara, CA (US); Tamar Bar-Kanarik, Ramat Hasharon (IL); Ji Li, Shanghai (CN); Cristian Florin Dumitrescu, Shannon (IE); Shweta Shrivastava, Bee Cave, TX (US); Patrick Connor, Beaverton, OR (US)

(73) Assignee: Intel Corporation, Santa Clara, CA (US)

(21) Appl. No.: 18/988,607

(22) Filed: Dec. 19, 2024

Related U.S. Application Data
(63) Continuation of application No. PCT/CN2024/125165, filed on Oct. 16, 2024.

(51) Int. Cl. G06F 13/40; G06F 13/16

(52) U.S. Cl. CPC G06F 13/4004; G06F 13/1684

(57) ABSTRACT

An apparatus includes a host interface; a network interface; hardware storage to store a flow table; and programmable circuitry comprising processors to implement network interface functionality and to: implement a hash table and an age context table, wherein the hash table and the age context table are to reference flow rules maintained in the flow table; process a synchronization packet for a flow by adding a flow rule for the flow to the flow table, adding a hash entry corresponding to the flow rule to the hash table, and adding an age context entry for the flow to the age context table; and process subsequent packets for the flow by performing a first lookup at the hash table to access the flow rule at the flow table and by performing a second lookup at the age context table to apply aging rules to the flow rule in the flow table.

### CROSS-REFERENCE TO RELATED APPLICATION

This application is a continuation of International Patent Application No. PCT/CN2024/125165, filed Oct. 16, 2024, which is incorporated by reference herein in its entirety.

### BACKGROUND OF THE DISCLOSURE

In highly virtualized environments, significant amounts of server resources are expended processing tasks that are beyond user applications. Such processing tasks can include hypervisors, container engines, network and storage functions, security, and large amounts of network traffic. To address these various processing tasks, programmable network interface devices with accelerators and network connectivity have been introduced. These programmable network interface devices are referred to as infrastructure processing units (IPUs), data processing units (DPUs), edge processing units (EPUs), programmable network devices, and so on. The programmable network interface devices can accelerate and manage infrastructure functions using dedicated and programmable cores deployed in the devices. The programmable network interface devices can provide for infrastructure offload and an extra layer of security by serving as a control point of the host for running infrastructure applications. By using a programmable network interface devices, the overhead associated with running infrastructure tasks can be offloaded from a server device.

### BRIEF DESCRIPTION OF THE DRAWINGS

Embodiments described herein are illustrated by way of example and not limitation in the figures of the accompanying drawings in which like references indicate similar elements, and in which:

FIG. 1 is a block diagram illustrating a computer system configured to implement one or more aspects of the embodiments described herein;

FIG. 2 is a block diagram of a system that includes selected components of a datacenter;

FIG. 3 is a block diagram of a portion of a datacenter, according to one or more examples of the present specification;

FIG. 4A-4C illustrates programmable forwarding elements and adaptive routing;

FIG. 5A-5B depicts example network interface devices;

FIG. 6 is a block diagram illustrating a programmable network interface and data processing unit;

FIG. 7 is a block diagram illustrating an IP core development system;

FIG. 8 is a block diagram illustrating an example computing environment for providing for stateful flow table management using programmable network interface devices, according to implementations herein;

FIG. 9 is a block diagram of an example programmable network interface device for providing stateful flow table management using programmable network interface devices, in accordance with implementations herein;

FIG. 10 is a block diagram of an example programmable network interface device for providing a hybrid software/hardware approach for stateful flow table management using programmable network interface devices, in accordance with implementations herein;

FIG. 11 is a block diagram of an example programmable network interface device for providing a software approach for stateful flow table management using programmable network interface devices, in accordance with implementations herein;

FIG. 12 is a flow diagram illustrating an embodiment of a method for providing a first hybrid approach for stateful flow table management using programmable network interface devices;

FIG. 13 is a flow diagram illustrating an embodiment of a method for providing a second hybrid approach for stateful flow table management using programmable network interface devices; and

FIG. 14 is a flow diagram illustrating an embodiment of a method providing a software approach for stateful flow table management using programmable network interface devices.

### DETAILED DESCRIPTION

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

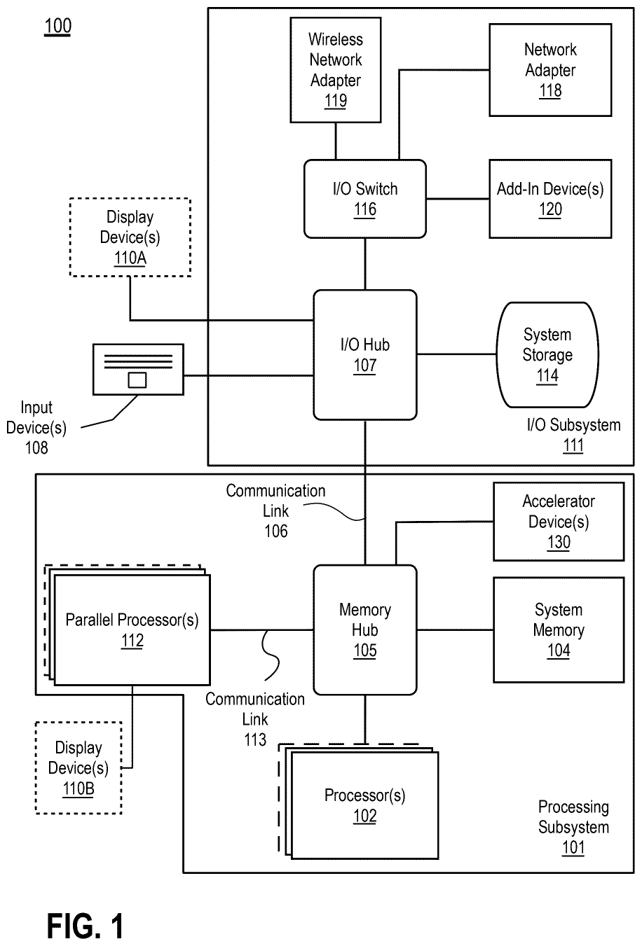

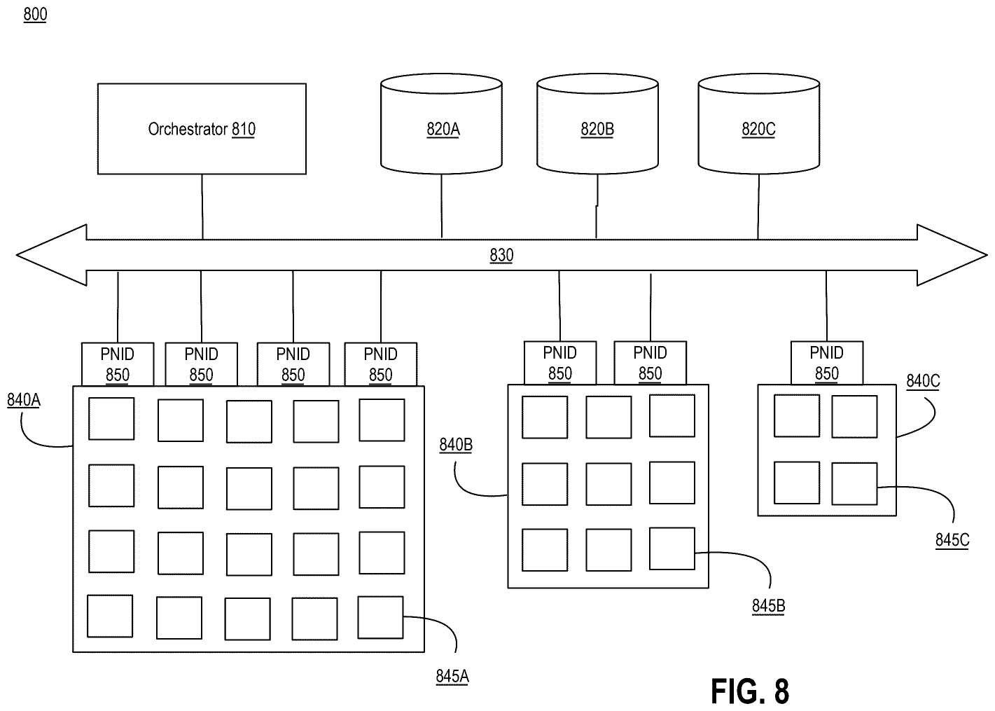

FIG. 1 is a block diagram illustrating a computing system 100 configured to implement one or more aspects of the embodiments described herein. In implementations herein, the example computing system 100 of FIG. 1 may include components to implement stateful flow table management using programmable network interface devices, in accordance with the discussion below with respect to FIGS. 8-14. The computing system 100 includes a processing subsystem 101 having one or more processor(s) 102, such as central processing units (CPUs) or other host processors, and a system memory 104, which may communicate via an interconnection path that may include a memory hub 105. The memory hub 105 may be a separate component within a chipset component or may be integrated within the one or more processor(s) 102. The memory hub 105 couples with an I/O subsystem 111 via a communication link 106. The I/O subsystem 111 includes an I/O hub 107 that can enable the computing system 100 to receive input from one or more input device(s) 108. Additionally, the I/O hub 107 can enable a display controller, which may be included in the one or more processor(s) 102, to provide outputs to one or more display device(s) 110A. In one embodiment the one or more display device(s) 110A coupled with the I/O hub 107 can include a local, internal, or embedded display device.

The processing subsystem 101, for example, includes one or more parallel processor(s) 112 coupled to memory hub 105 via a communication link 113, such as a bus or fabric. The communication link 113 may be one of any number of standards-based communication link technologies or protocols, such as, but not limited to PCI Express, or may be a vendor specific communications interface or communications fabric. The one or more parallel processor(s) 112 may form a computationally focused parallel or vector processing system that can include a large number of processing cores and/or processing clusters, such as a many integrated core (MIC) processor. For example, the one or more parallel processor(s) 112 form a graphics processing subsystem that can output pixels to one of the one or more display device(s) 110A coupled via the I/O hub 107. The one or more parallel processor(s) 112 can also include a display controller and display interface (not shown) to enable a direct connection to one or more display device(s) 110B.

Within the I/O subsystem 111, a system storage unit 114 can connect to the I/O hub 107 to provide a storage mechanism for the computing system 100. An I/O switch 116 can be used to provide an interface mechanism to enable connections between the I/O hub 107 and other components, such as a network adapter 118 and/or wireless network adapter 119 that may be integrated into the platform, and various other devices that can be added via one or more add-in device(s) 120. The add-in device(s) 120 may also include, for example, one or more external graphics processor devices, graphics cards, and/or compute accelerators. The network adapter 118 can be an Ethernet adapter or another wired network adapter. The wireless network adapter 119 can include one or more of a Wi-Fi, Bluetooth, near field communication (NFC), or other network device that includes one or more wireless radios.

The computing system 100 can include other components not explicitly shown, including USB or other port connections, optical storage drives, video capture devices, and the like, which may also be connected to the I/O hub 107. Communication paths interconnecting the various components in FIG. 1 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), Internet Protocol (IP), User Datagram Protocol (UDP), quick UDP Internet Connections (QUIC), RDMA over Converged Ethernet (ROCE), Ultra Ethernet Transport (UET), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, Open Coherent Accelerator Processor Interface (CAPI), Gen-Z, Cache Coherent Interconnect for Accelerators (CCIX), 3rd Generation Partnership Projects (3GPP) Long Term Evolution (LTE) (e.g., 4th generation (4G)), 3GPP 5th generation (5G), and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe. In one embodiment, time-aware communication protocols are supported, including time-aware RDMA, time-aware NVME, and time-aware NVME-oF, in which a precise time and rate of data consumption is used to control the transfer of data.

The one or more parallel processor(s) 112 may incorporate circuitry optimized for graphics and video processing, including, for example, video output circuitry, and constitutes a graphics processing unit (GPU). Alternatively or additionally, the one or more parallel processor(s) 112 can incorporate circuitry optimized for general purpose processing, while preserving the underlying computational architecture, described in greater detail herein. Components of the computing system 100 may be integrated with one or more other system elements on a single integrated circuit. For example, the one or more parallel processor(s) 112, memory hub 105, processor(s) 102, and I/O hub 107 can be integrated into a system on chip (SoC) integrated circuit. Alternatively, the components of the computing system 100 can be integrated into a single package to form a system in package (SiP) configuration. In one embodiment at least a portion of the components of the computing system 100 can be integrated into a multi-chip module (MCM), which can be interconnected with other multi-chip modules into a modular computing system.

In some configurations, the computing system 100 includes one or more accelerator device(s) 130 coupled with the memory hub 105, in addition to the processor(s) 102 and the one or more parallel processor(s) 112. The accelerator device(s) 130 are configured to perform domain specific acceleration of workloads to handle tasks that are computationally intensive or utilize high throughput. The accelerator device(s) 130 can reduce the burden placed on the processor(s) 102 and/or parallel processor(s) 112 of the computing system 100. The accelerator device(s) 130 can include but are not limited to smart network interface cards, data processing units, cryptographic accelerators, storage accelerators, artificial intelligence (AI) accelerators, neural processing units (NPUs), storage accelerators, and/or video transcoding accelerators.

It will be appreciated that the computing system 100 shown herein is illustrative and that variations and modifications are possible. The connection topology, including the number and arrangement of bridges, the number of processor(s) 102, and the number of parallel processor(s) 112, may be modified as desired. For instance, system memory 104 can be connected to the processor(s) 102 directly rather than through a bridge, while other devices communicate with system memory 104 via the memory hub 105 and the processor(s) 102. In other alternative topologies, the parallel processor(s) 112 are connected to the I/O hub 107 or directly to one of the one or more processor(s) 102, rather than to the memory hub 105. In other embodiments, the I/O hub 107 and memory hub 105 may be integrated into a single chip. It is also possible that two or more sets of processor(s) 102 are attached via multiple sockets, which can couple with two or more instances of the parallel processor(s) 112.

Some of the particular components shown herein are optional and may not be included in all implementations of the computing system 100. For example, any number of add-in cards or peripherals may be supported, or some components may be eliminated. Furthermore, some architectures may use different terminology for components similar to those illustrated in FIG. 1.

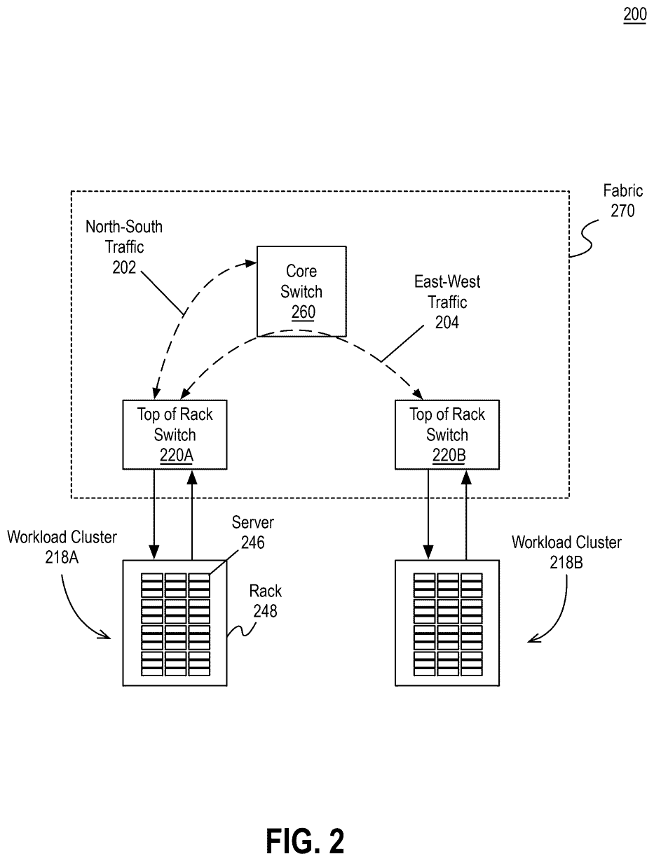

FIG. 2 is a block diagram of a system 200 that includes selected components of a datacenter. In implementations herein, the example system 200 of FIG. 2 may include components to implement stateful flow table management using programmable network interface devices, in accordance with the discussion below with respect to FIGS. 8-14. The components of the illustrated datacenter may reside, for example within a cloud service provider (CSP), or another datacenter, which may be, by way of nonlimiting example, a traditional enterprise datacenter, an enterprise “private cloud,” or a “public cloud,” providing services such as infrastructure as a service (IaaS), platform as a service (PaaS), or software as a service (SaaS). The system 200 includes some number of workload clusters, including but not limited to workload cluster 218A and workload cluster 218B. The workload clusters may be clusters of individual servers, blade servers, rackmount servers, or any other suitable server topology.

The system 200 may include workload clusters 218A-218B. The workload clusters 218A-218B can include a rack 248 that houses multiple servers (e.g., server 246). The rack 248 and the servers of the workload clusters 218A-218B may conform to the rack unit (“U”) standard, in which one rack unit conforms to a 19 inch wide rack frame and a full-sized industry standard rack accommodates 42 units (42U) of equipment. One unit (1U) of equipment (e.g., a 1U server) may be 1.75 inches high and approximately 36 inches deep. In various configurations, compute resources such as processors, memory, storage, accelerators, and switches may fit into some multiple of rack units within a rack 248.

A server 246 may host a standalone operating system configured to provide server functions, or the servers may be virtualized. A virtualized server may be under the control of a virtual machine manager (VMM), hypervisor, and/or orchestrator, and may host one or more virtual machines, virtual servers, or virtual appliances. The workload clusters 218A-218B may be collocated in a single datacenter, or may be located in different geographic datacenters. Depending on the contractual agreements, some servers may be specifically dedicated to certain enterprise clients or tenants while other servers may be shared.

The various devices in a datacenter may be interconnected via a switching fabric 270, which may include one or more high speed routing and/or switching devices. The switching fabric 270 may provide north-south traffic 202 (e.g., traffic to and from the wide area network (WAN), such as the internet), and east-west traffic 204 (e.g., traffic across the datacenter). Historically, north-south traffic 202 accounted for the bulk of network traffic, but as web services become more complex and distributed, the volume of east-west traffic 204 has risen. In many datacenters, cast-west traffic 204 now accounts for the majority of traffic. Furthermore, as the capability of a server 246 increases, traffic volume may further increase. For example, a server 246 may provide multiple processor slots, with a slot accommodating a processor having four to eight cores, along with sufficient memory for the cores. Thus, a server may host a number of VMs that may be a source of traffic generation.

To accommodate the large volume of traffic in a datacenter, a highly capable implementation of the switching fabric 270 may be provided. The illustrated implementation of the switching fabric 270 is an example of a flat network in which a server 246 may have a direct connection to a top-of-rack switch (ToR switch 220A-220B) (e.g., a “star” configuration). ToR switch 220A can connect with a workload cluster 218A, while ToR switch 220B can connect with workload cluster 218B. A ToR switch 220A-220B may couple to a core switch 260. This two-tier flat network architecture is shown as an illustrative example and other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The switching fabric 270 may be provided by any suitable interconnect using any suitable interconnect protocol. For example, a server 246 may include a fabric interface (FI) of some type, a network interface card (NIC), or other host interface. The host interface itself may couple to one or more processors via an interconnect or bus, such as PCI, PCIe, or similar, and in some cases, this interconnect bus may be considered to be part of the switching fabric 270. The switching fabric may also use PCIe physical interconnects to implement more advanced protocols, such as compute express link (CXL).

The interconnect technology may be provided by a single interconnect or a hybrid interconnect, such as where PCIe provides on-chip communication, 1 Gb or 10 Gb copper Ethernet provides relatively short connections to a ToR switch 220A-220B, and optical cabling provides relatively longer connections to core switch 260. Interconnect technologies include, by way of nonlimiting example, Ultra Path Interconnect (UPI), FibreChannel, Ethernet, FibreChannel over Ethernet (FCoE), InfiniBand, PCIe, NVLink, or fiber optics, to name just a few. Some of these will be more suitable for certain deployments or functions than others, and selecting an appropriate fabric for the instant application is an exercise of ordinary skill.

In one embodiment, the switching elements of the switching fabric 270 are configured to implement switching techniques to improve the performance of the network in high usage scenarios. Example advanced switching techniques include but are not limited to adaptive routing, adaptive fault recovery, and adaptive and/or telemetry-based congestion control.

Adaptive routing enables a ToR 220A-220B switch and/or core switch 260 to select the output port to which traffic is switched based on the load on the selected port, assuming unconstrained port selection is enabled. An adaptive routing table can configure the forwarding tables of switches of the switching fabric 270 to select between multiple ports between switches when multiple connections are present between a given set of switches in an adaptive routing group. Adaptive fault recovery (e.g., self-healing) enables the automatic selection of an alternate port if the ported selected by the forwarding table port is in a failed or inactive state, which enables rapid recovery in the event of a switch-to-switch port failure. A notification can be sent to neighboring switches when adaptive routing or adaptive fault recovery becomes active in a given switch. Adaptive congestion control configures a switch to send a notification to neighboring switches when port congestion on that switch exceeds a configured threshold, which may cause those neighboring switches to adaptively switch to uncongested ports on that switch or switches associated with an alternate route to the destination.

Telemetry-based congestion control uses real-time monitoring of telemetry from network devices, such as switches within the switching fabric 270, to detect when congestion will begin to impact the performance of the switching fabric 270 and proactively adjust the switching tables within the network devices to prevent or mitigate the impending congestion. A ToR 220A-220B switch and/or core switch 260 can implement a built-in telemetry-based congestion control algorithm or can provide an application programming interface (API) though which a programmable telemetry-based congestion control algorithm can be implemented. A continuous feedback loop may be implemented in which the telemetry-based congestion control system continuously monitors the network and adjusts the traffic flow in real-time based on ongoing telemetry data. Learning and adaptation can be implemented by the telemetry-based congestion control system in which the system can adapt to changing network conditions and improve its congestion control strategies based on historical data and trends.

Note however that while high-end fabrics are provided herein by way of illustration, more generally, the switching fabric 270 may include any suitable interconnect or bus for the particular application, including legacy interconnects used to implement a local area network (LANs), synchronous optical networks (SONET), asynchronous transfer mode (ATM) networks, wireless networks such as Wi-Fi and Bluetooth, 4G wireless, 5G wireless, digital subscriber line (DSL) interconnects, multimedia over coax alliance (MoCA) interconnects, or similar wired or wireless networks. It is also expressly anticipated that in the future, new network technologies will arise to supplement or replace some of those listed here, and any such future network topologies and technologies can be or form a part of the switching fabric 270.

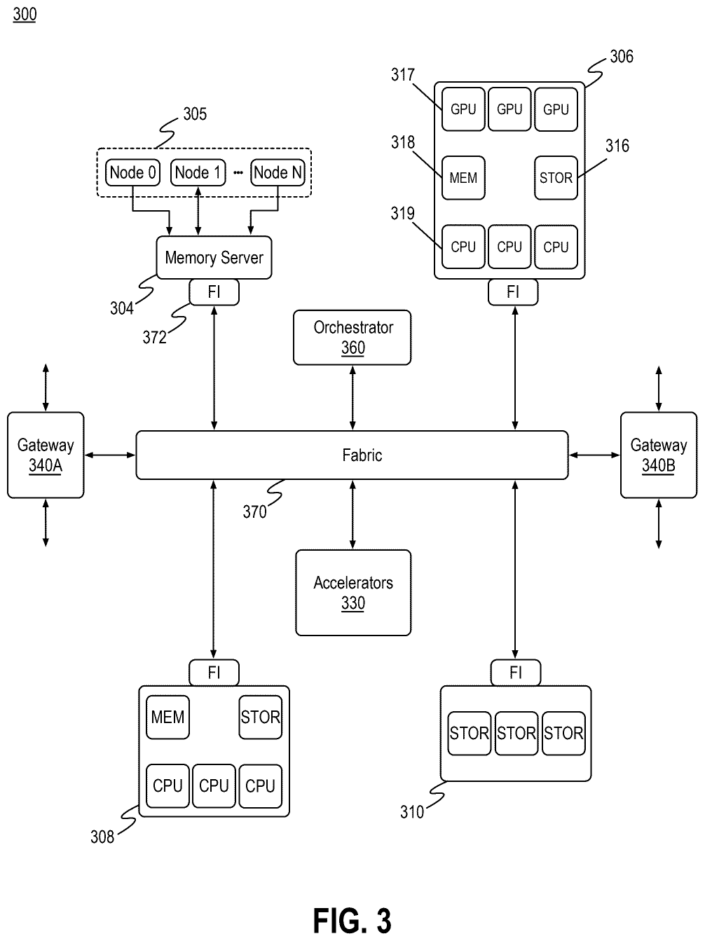

FIG. 3 is a block diagram of a portion of a datacenter 300, according to one or more examples of the present specification. In implementations herein, the example datacenter 300 of FIG. 3 may include components to implement stateful flow table management using programmable network interface devices, in accordance with the discussion below with respect to FIGS. 8-14. The illustrated portion of the datacenter 300 is not intended to include all components of a datacenter. The illustrated portion may be duplicated multiple times within the datacenter 300 and/or the datacenter 300 may include portions beyond the illustrated portions, depending on the capacity and functionality intended to be provided by the datacenter 300. The datacenter 300 may be, in various embodiments include components of the datacenter of the system 200 of FIG. 2, or may be a different datacenter.

The datacenter 300 includes a number of logic elements forming a plurality of nodes, where a node may be provided by a physical server, a group of servers, or other hardware. A server may also host one or more virtual machines, as appropriate to its application. A fabric 370 is provided to interconnect various aspects of datacenter 300. The fabric 370 may be provided by any suitable interconnect technology, including but not limited to InfiniBand, Ethernet, PCIe, or CXL. The fabric 370 of the datacenter 300 may be a version of and/or include elements of the switching fabric 270 of the system 200 of FIG. 2. The fabric 370 of datacenter 300 can interconnect datacenter elements that include server nodes (e.g., memory server node 304, heterogenous compute server node 306, CPU server node 308, storage server node 310), accelerators 330, gateways 340A-340B to other fabrics, fabric architectures, or interconnect technologies, and an orchestrator 360.

The server nodes of the datacenter 300 can include but are not limited to a memory server node 304, a heterogenous compute server node 306, a CPU server node 308, and a storage server node 310. The heterogenous compute server node 306 and a CPU server node 308 can perform independent operations for different tenants or cooperatively perform operations for a single tenant. The heterogenous compute server node 306 and a CPU server node 308 can also host virtual machines that provide virtual server functionality to tenants of the datacenter.

The server nodes can connect with the fabric 370 via a fabric interface 372. The specific type of fabric interface 372 that is used depends at least in part on the technology or protocol that is used to implement the fabric 370. For example, where the fabric 370 is an Ethernet fabric, the fabric interface 372 may be an Ethernet network interface controller. Where the fabric 370 is a PCIe-based fabric, the fabric interfaces may be PCIe-based interconnects. Where the fabric 370 is an InfiniBand fabric, the fabric interface 372 of the heterogenous compute server node 306 and a CPU server node 308 may be a host channel adapter (HCA), while the fabric interface 372 of the memory server node 304 and storage server node 310 may be a target channel adapter (TCA). TCA functionality may be an implementation-specific subset of HCA functionality. The various fabric interfaces may be implemented as intellectual property (IP) blocks that can be inserted into an integrated circuit as a modular unit, as can other circuitry within the datacenter 300.

The heterogenous compute server node 306 includes multiple CPU sockets that can house a CPU 319, which may be, but is not limited to an Intel® Xeon™ processor including a plurality of cores. The CPU 319 may also be, for example, a multi-core datacenter class ARM® CPU, such as an NVIDIA® Grace™ CPU. The heterogenous compute server node 306 includes memory devices 318 to store data for runtime execution and storage devices 316 to enable the persistent storage of data within non-volatile memory devices. The heterogenous compute server node 306 is enabled to perform heterogenous processing via the presence of GPUs (e.g., GPU 317), which can be used, for example, to perform high-performance compute (HPC), media server, cloud gaming server, and/or machine learning compute operations. In one configuration, the GPUs may be interconnected and CPUs of the heterogenous compute server node 306 via interconnect technologies such as PCIe, CXL, or NVLink.

The CPU server node 308 includes a plurality of CPUs (e.g., CPU 319), memory (e.g., memory devices 318) and storage (storage devices 316) to execute applications and other program code that provide server functionality, such as web servers or other types of functionality that is remotely accessible by clients of the CPU server node 308. The CPU server node 308 can also execute program code that provides services or micro-services that enable complex enterprise functionality. The fabric 370 will be provisioned with sufficient throughput to enable the CPU server node 308 to be simultaneously accessed by a large number of clients, while also retaining sufficient throughput for use by the heterogenous compute server node 306 and to enable the use of the memory server node 304 and the storage server node 310 by the heterogenous compute server node 306 and the CPU server node 308. Furthermore, in one configuration, the CPU server node 308 may rely primarily on distributed services provided by the memory server node 304 and the storage server node 310, as the memory and storage of the CPU server node 308 may not be sufficient for all of the operations intended to be performed by the CPU server node 308. Instead, a large pool of high-speed or specialized memory may be dynamically provisioned between a number of nodes, so that the nodes have access to a large pool of resources, but those resources do not sit idle when that particular node does not utilize them. A distributed architecture of this type is possible due to the high speeds and low latencies provided by the fabric 370 of contemporary datacenters and may be advantageous because the resources do not have to be over-provisioned for the server nodes.

The memory server node 304 can include memory nodes 305 having memory technologies that are suitable for the storage of data used during the execution of program code by the heterogenous compute server node 306 and the CPU server node 308. The memory nodes 305 can include volatile memory modules, such as DRAM modules, and/or non-volatile memory technologies that can operate similar to DRAM speeds, such that those modules have sufficient throughput and latency performance metrics to be used as a tier of system memory at execution runtime. The memory server node 304 can be linked with the heterogenous compute server node 306 and/or CPU server node 308 via technologies such as CXL.mem, which enables memory access from a host to a device. In such configuration, a CPU 319 of the heterogenous compute server node 306, a CPU server node 308 can link to the memory server node 304 and access the memory nodes 305 of the memory server node 304 in a similar manner as, for example, the CPU 319 of the heterogenous compute server node 306 can access device memory of a GPU within the heterogenous compute server node 306. For example, the memory server node 304 may provide remote direct memory access (RDMA) to the memory nodes 305, in which, for example, the CPU server node 308 may access memory resources on the memory server node 304 via the fabric 370 using direct memory access (DMA) operations, in a similar manner as how the CPU would access its own onboard memory.

The memory server node 304 can be used by the heterogenous compute server node 306 and CPU server node 308 to expand the runtime memory that is available during memory-intensive activities such as the training of machine learning models. A tiered memory system can be enabled in which model data can be swapped into and out of the memory devices 318 of the heterogenous compute server node 306 to memory of the memory server node 304 at higher performance and/or lower latency than local storage (e.g., storage devices 316). During workload execution setup, the entire working set of data may be loaded into one or more of the memory nodes 305 of the memory server node 304 and loaded into the memory devices 318 of the heterogenous compute server node 306 during execution of a heterogenous workload.

The storage server node 310 provides storage functionality to the heterogenous compute server node 306, the CPU server node 308, and potentially the memory server node 304. The storage server node 310 may provide a networked bunch of disks or just a bunch of disks (JBOD), program flash memory (PFM), redundant array of independent disks (RAID), redundant array of independent nodes (RAIN), network attached storage (NAS), or other nonvolatile memory solutions. In one configuration, the storage server node 310 can couple with the heterogenous compute server node 306, the CPU server node 308, and/or the memory server node 304 such as NVMe-oF, which enables the NVME protocol to be implemented over the fabric 370. In such configurations, the fabric interface 372 of those servers may be smart interfaces that include hardware to accelerate NVMe-oF operations.

The accelerators 330 within the datacenter 300 can provide various accelerated functions, including hardware or coprocessor acceleration for functions such as packet processing, encryption, decryption, compression, decompression, network security, or other accelerated functions in the datacenter. In some examples, accelerators 330 may include deep learning accelerators, such as neural processing units (NPU), that can receive offload of matrix multiply operations of other neural network operations from the heterogenous compute server node 306 or the CPU server node 308. In some configurations, the accelerators 330 may reside in a dedicated accelerator server or distributed throughout the various server nodes of the datacenter 300. For example, an NPU may be directly attached to one or more CPU cores within the heterogenous compute server node 306 or the CPU server node 308. In some configurations, the accelerators 330 can include or be included within smart network controllers, infrastructure processing units (IPUs), or data processing units, which combine network controller functionality with accelerator, processor, or coprocessor functionality. The accelerators 330 can also include edge processing units (EPU) to perform real-time inference operations at the edge of the network.

In one configuration, the datacenter 300 can include gateways 340A-340B from the fabric 370 to other fabrics, fabric architectures, or interconnect technologies. For example, where the fabric 370 is an InfiniBand fabric, the gateways 340A-340B may be gateways to an Ethernet fabric. Where the fabric 370 is an Ethernet fabric, the gateways 340A-340B may include routers to route data to other portions of the datacenter 300 or to a larger network, such as the Internet. For example, a first gateway 340A may connect to a different network or subnet within the datacenter 300, while a second gateway 340B may be a router to the Internet.

The orchestrator 360 manages the provisioning, configuration, and operation of network resources within the datacenter 300. The orchestrator 360 may include hardware or software that executes on a dedicated orchestration server. The orchestrator 360 may also be embodied within software that executes, for example, on the CPU server node 308 that configures software defined networking (SDN) functionality of components within the datacenter 300. In various configurations, the orchestrator 360 can enable automated provisioning and configuration of components of the datacenter 300 by performing network resource allocation and template-based deployment. Template-based deployment is a method for provisioning and managing IT resources using predefined templates, where the templates may be based on standard templates utilized by the government, service provider, financial, standard or customer. The template may also dictate service level agreements (SLA) or service level obligations (SLO). The orchestrator 360 can also perform functionality including but not limited to load balancing and traffic engineering, network segmentation, security automation, real-time telemetry monitoring, and adaptive switching management, including telemetry-based adaptive switching. In some configurations, the orchestrator 360 can also provide multi-tenancy and virtualization support by enabling virtual network management, including the creation and deletion of virtual LANs (VLANs) and virtual private networks (VPNs), and tenant isolation for multi-tenant datacenters.

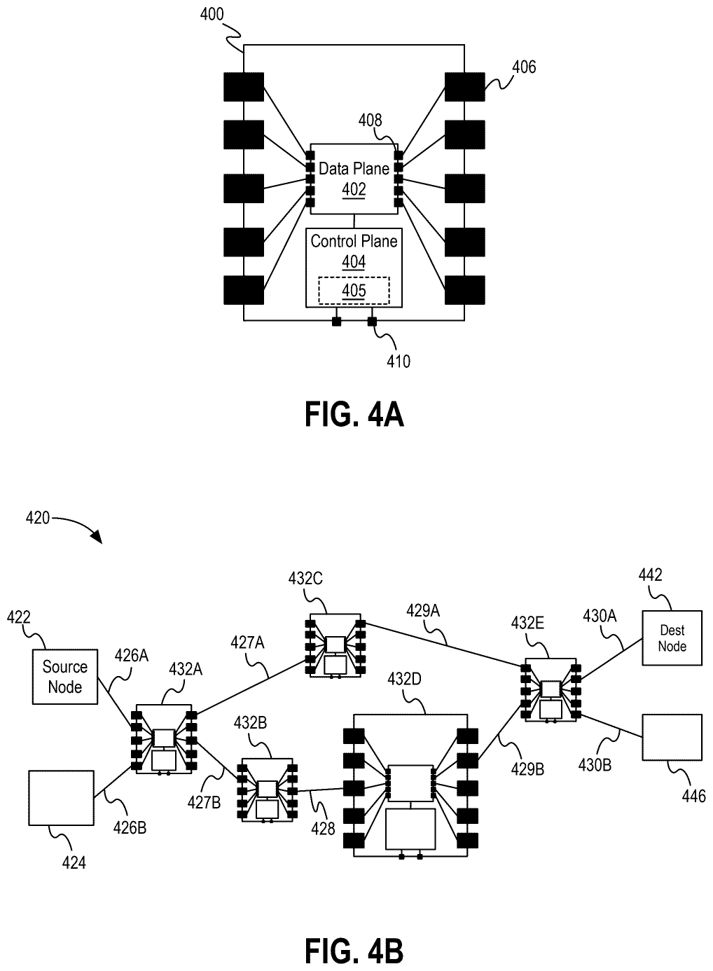

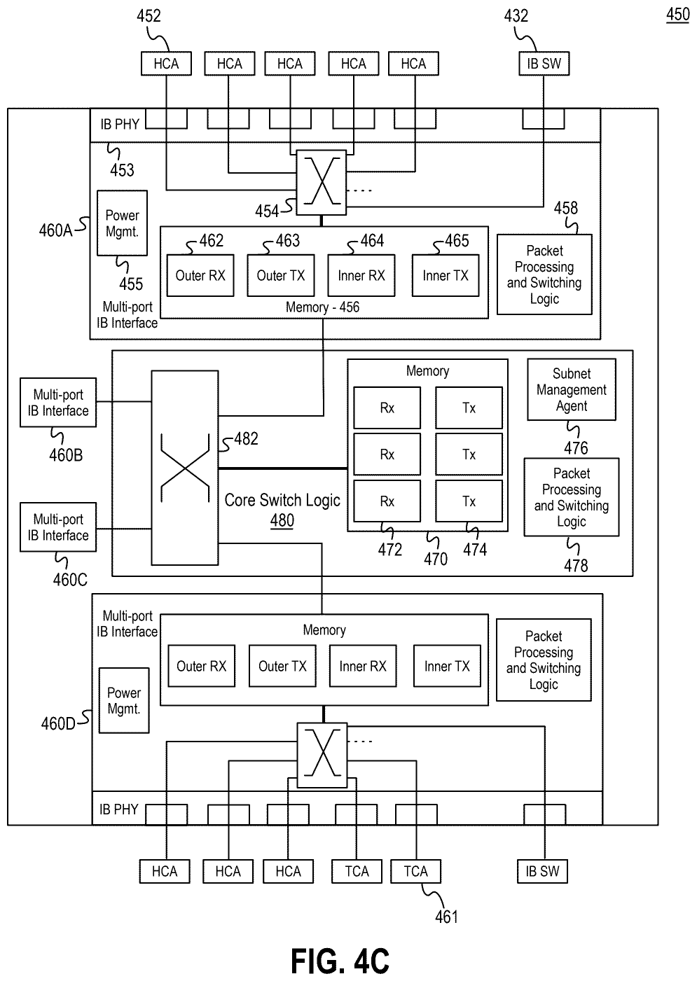

FIGS. 4A-4C illustrates programmable forwarding elements and adaptive routing. In implementations herein, the example programmable forwarding elements and adaptive routing of FIGS. 4A-4C may be utilized as part of implementing stateful flow table management using programmable network interface devices, in accordance with the discussion below with respect to FIGS. 8-14. FIG. 4A illustrates a forwarding element that includes a control plane and a programmable data plane. FIG. 4B illustrates a network having switching devices configured to perform adaptive routing and telemetry-based congestion control. FIG. 4C illustrates an InfiniBand switch including multi-port IB interfaces.

FIG. 4A shows a forwarding element 400 that can be configured to forward data messages within a network based on a program provided by a user. The program, in some embodiments, includes instructions for forwarding data messages, as well as performing other processes such as firewall, denial of service attack protection, and load balancing operations. The forwarding element 400 can be any type of forwarding element, including but not limited to a switch, a router, or a bridge. The forwarding element 400 can forward data messages associated with various technologies, such as but not limited to Ethernet, Ultra Ethernet, InfiniBand, or NVLink.

In various network configurations, the forwarding element is deployed as a non-edge forwarding element in the interior of the network to forward data messages from a source device to a destination device. In network configurations, the forwarding element 400 is deployed as an edge forwarding element at the edge of the network to connect to compute devices (e.g., standalone or host computers) that serve as sources and destinations of the data messages. As a non-edge forwarding element, the forwarding element 400 forwards data messages between forwarding elements in the network, such as through an intervening network fabric. As an edge forwarding element, the forwarding element 400 forwards data messages to and from edge compute devices, to other edge forwarding elements and/or to non-edge forwarding elements.

The forwarding element 400 includes circuitry to implement a data plane 402 that performs the forwarding operations of the forwarding element 400 to forward data messages received by the forwarding element to other devices. The forwarding element 400 also includes circuitry to implement a control plane 404 that configures the data plane circuit. Additionally, the forwarding element 400 includes physical ports 406 that receive data messages from, and transmit data messages to, devices outside of the forwarding element 400. The data plane 402 includes ports 408 that receive data messages from the physical ports 406 for processing. The data messages are processed and forwarded to another port on the data plane 402, which is connected to another physical port of the forwarding element 400. In addition to being associated with physical ports of the forwarding element 400, some of the ports 408 on the data plane 402 may be associated with other modules of the data plane 402.

The data plane includes programmable packet processor circuits that provide several programmable message-processing stages that can be configured to perform the data-plane forwarding operations of the forwarding element 400 to process and forward data messages to their destinations. These message-processing stages perform these forwarding operations by processing data tuples (e.g., message headers) associated with data messages received by the data plane 402 in order to determine how to forward the messages. The message-processing stages include match-action units (MAUs) that try to match data tuples (e.g., header vectors) of messages with table records that specify action to perform on the data tuples. In some embodiments, table records are populated by the control plane 404 and are not known when configuring the data plane to execute a program provided by a network user. The programmable message-processing circuits are grouped into multiple message-processing pipelines. The message-processing pipelines can be ingress or egress pipelines before or after the forwarding element's traffic management stage that directs messages from the ingress pipelines to egress pipelines.

The specifics of the hardware of the data plane 402 depends on the communication protocol implemented via the forwarding element 400. Ethernet switches use application specific integrated circuits (ASICs) designed to handle Ethernet frames and the TCP/IP protocol stack. These ASICs are optimized for a broad range of traffic types, including unicast, multicast, and broadcast. Ethernet switch ASICs are generally designed to balance cost, power consumption, and performance, although high-end Ethernet switches may support more advanced features such as deep packet inspection and advanced QoS (Quality of Service). InfiniBand switches use specialized ASICs designed for ultra-low latency and high throughput. These ASICs enable features such as optimized for handling the InfiniBand protocol and provide support for RDMA and other features that utilize precise timing and high-speed data processing, although high-end Ethernet switches may support RoCE (RDMA over Converged Ethernet), which offers similar benefits to InfiniBand but with higher latency compared to native InfiniBand RDMA.

The forwarding element 400 may also be configured as an NVLink switch (e.g., NVSwitch), which is used to interconnect multiple graphics processors via the NVLink connection protocol. When configured as an NVLink switch, the forwarding element 400 can provide GPU servers with increased GPU to GPU bandwidth relative to GPU servers interconnected via InfiniBand. An NVLink switch can reduce network traffic hotspots that may occur when interconnected GPU-equipped servers execute operations such as distributed neural network training.

In general, where the data plane 402, in concert with a program executed on the data plane 402 (e.g., a program written in the P4 language), performs message or packet forwarding operations for incoming data, the control plane 404 determines how messages or packets should be forwarded. The behavior of a program executed on the data plane 402 is determined in part by the control plane 404, which populates match-action tables with specific forwarding rules. The forwarding rules that are used by the program executed on the data plane 402 are independent of the data plane program itself. In one configuration, the control plane can couple with a management port 410 that enables administrator configuration of the forwarding element 400. The data connection that is established via the management port 410 is separate from the data connections for ingress and egress data ports. In one configuration, the management ports 410 may connect with a management plane 405, which facilitates administrative access to the device, enables the analysis of device state and health, and enables device reconfiguration. The management plane 405 may be a portion of the control plane 404 or in direct communication with the control plane 404. In one implementation, there is no direct access for the administrator to components of the control plane 404. Instead, information is gathered by the management plane 405 and the changes to the control plane 404 are carried out by the management plane 405.

FIG. 4B shows a network 420 having switches 432A-432E with support for adaptive routing and telemetry-based congestion control. The network 420 can be implemented using a variety of communication protocols described herein. In one embodiment, the network 420 is implemented using the InfiniBand protocol. In one embodiment, the network 420 is an Ethernet, converged Ethernet, or Ultra Ethernet network. The network 420 may include aspects of the fabric 370 of FIG. 3. The switches 432A-432E may be an implementation of the forwarding element 400 of FIG. 4A. The network 420 provides packet-based communication for multiple nodes (e.g., node 424, node 446), including a source node 422 and a destination node 442 of a data transfer to be performed over the network 420. Packets of a flow are forwarded over a route through the network 420 that traverses the switches (switch 432A-432E) and links (link 426A-426B, 427A-427B, 428, 429A-429B, 430A-430B) of the network 420. In an InfiniBand application, the switches and links belong to a certain InfiniBand subnet that is managed by a Subnet Manager (SM), which may be included within one of the switches (e.g., switch 432D). The source node 422 and the destination node 442 are the source and destination nodes for an example dataflow. Depending on the configuration of the network 420, packets may flow from any node to any other node via one or more paths.

The switches 432A-432E include a data plane 402, a control plane 404, a management plane 405, and physical ports 406, as in the forwarding element 400 of FIG. 4A. A processor of the control plane 404 can be used to implement adaptive routing techniques to adjust a route between the source node 422 and the destination node 442 based on the current state of the network. During network operation, the route from the source node 422 to the destination node 442 may at some point become unsuitable or compromised in its ability to transfer packets due to various events, such as congestion, link fault, or head-of-line blocking. Should such scenario occur, the switched 432A-432E can be configured to dynamically adapt the route of the packets that flow along a compromised path.

An adaptive routing (AR) event may be detected by one of the switches along a route that becomes compromised, for example, when the switch when it attempts to output packets on a designated output port. For example, an example data from the source node 422 to the destination node 442 can traverse links through switches of the network. An AR event may be detected by switch 432D for link 429B, for example, in response to congestion or a link fault associated with link 429B. Upon detecting the AR event, switch 432D, as the detecting switch, generates an adaptive routing notification (ARN), which has an identifier that distinguishes an ARN packet from other packet types. In various embodiments, the ARN includes parameters such as an identifier for the detecting switch, the type of AR event, and the source and destination address of the flow that triggered the AR event, and/or any other suitable parameters. The detecting switch sends the ARN backwards along the route to the preceding switches. The ARN may include a request for notified switches to modify the route to avoid traversal of the detected switch. A notified switch can then evaluate whether its routes may be modified to bypass the detecting switch. Otherwise, the switch forwards the ARN to the previous preceding switch along the route. In this scenario, switch 432B is not able to avoid switch 432D and will relay the ARN to switch 432A. Switch 432A can determine to adapt the route to the destination node 442 by using link 427A to switch 432C. Switch 432C can reach switch 432E via link 429A, allowing packets from the source node 422 to reach the destination node 442 while bypassing the AR event related to link 429B.

In various configurations, the network 420 can also adapt to congestion scenarios via programmable data planes within the switches 432A-432E that are able to execute data plane programs to implement in-network congestion control algorithms (CCAs) for TCP over Ethernet-based fabrics. Using in-band network telemetry (INT), programmable data planes within the switches 432A-432E can become aware when a port or link along a route is becoming congested and preemptively seek to route packets over alternate paths. For example, switch 432A can load balance traffic to the destination node 442 between link 427A and link 427B based on the level of congestion seen on the routes downstream from those links.

FIG. 4C shows an InfiniBand switch 450, which may be an implementation of the forwarding element 400 of FIG. 4A. The InfiniBand switch 450 includes a programmable data plane and is configurable to perform adaptive routing and telemetry-based congestion control as described herein. The InfiniBand switch 450 includes multi-port IB interfaces 460A-460D and core switch logic 480. The multi-port IB interfaces 460A-460D include multiple ports. In one embodiment, a single instance of a physical interface (IB PHY 453) is present, with input and output buffers associated with a port. In one embodiment, ports have a separate physical interfaces. The ports can couple with, for example, an HCA 452, a TCA 461, or another InfiniBand switch 432. The multi-port IB interfaces 460A-460D can include a crossbar switch 454 that is configured to selectively couple input and output port buffers to local memory 456. The crossbar switch 454 is a non-blocking crossbar switch that provides direct and low latency switching with a fixed or variable packet size.

The local memory 456 includes multiple queues, including an outer receive queue 462, an outer transmit queue 463, an inner receive queue 464, and an inner transmit queue 465. The outer queues are used for data that is received at a given multi-port IB interface that is to be forwarded back out the same multi-port IB interface. The inner queues are used for data that is forwarded out a different multi-port IB interface than used to receive the data. Other types of queue configurations may be implemented in local memory 456. For example, different queues may be present to support multiple traffic classes, either on an individual port basis, shared port basis, or a combination thereof. The multi-port IB interfaces 460A-460D includes power management circuitry 455, which can adjust a power state of circuitry within the respective multi-port IB interface. Additionally power management logic that performs similar operations may be implemented as part of core switch logic.

The multi-port IB interfaces 460A-460D include packet processing and switching logic 458, which is generally used to perform aspects of packet processing and/or switching operations that are performed at the local multi-port level rather than across the IB switch as a whole. Depending on the implementation, the packet processing and switching logic 458 can be configured to perform a subset of the operations of the packet processing and switching logic 478 within the core switch logic 480, or can be configured with the full functionality of the packet processing and switching logic 478 within the core switch logic 480. The processing functionality of the packet processing and switching logic 458 may vary, depending on the complexity of the operations and/or speed the operations are to be performed. For example, the packet processing and switching logic 458 can include processors ranging from microcontrollers to multi-core processors. A variety of types or architectures of multi-core processors may also be used. Additionally, a portion of the packet processing operations may be implemented by embedded hardware logic.

The core switch logic 480 includes a crossbar 482, memory 470, a subnet management agent (SMA 476), and packet processing and switching logic 478. The crossbar 482 is a non-blocking low latency crossbar that interconnects the multi-port IB interfaces 460A-460D and connects with the memory 470. The memory 470 includes receive queues 472 and transmit queues 474. In one embodiment, packets to be switched between the multi-port IB interfaces 460A-460D can be received by the crossbar 482, stored in one of the receive queues 472, processed by the packet processing and switching logic 478, and stored in a transmit queues 474 for transmission to the outbound multi-port IB interface. In implementations that do not use the multi-port IB interfaces 460A-460D, the core switch logic 480 and crossbar 482 switches packets directly between I/O buffers with the receive queues 472 and transmit queues 474 within the memory 470.

The packet processing and switching logic 478 includes programmable functionality and can execute data plane programs via a variety of types or architectures of multi-core processors. The packet processing and switching logic 478 is representative of the applicable circuitry and logic for implementing switching operations, as well as packet processing operations beyond which may be performed at the ports themselves. Processing elements of the packet processing and switching logic 478 executes software and/or firmware instructions configured to implement packet processing and switch operations. Such software and/or firmware may be stored in non-volatile storage on the switch itself. The software may also be downloaded or updated over a network in conjunction with initializing operations of the InfiniBand switch 450.

The SMA 476 is configurable to manage, monitor, and control functionality of the InfiniBand switch 450. The SMA 476 is also an agent of and in communication of the subnet manager (SM) for the subnet associated with the InfiniBand switch 450. The SM is the entity that discovers the devices within the subnet and performs a periodic sweep of the subnet to detect changes to the subnet's topology. One SMA within a subnet can be elected the primary SMA for the subnet and act as the SM. Other SMAs within the subnet will then communicate with that SMA. Alternatively, the SMA 476 can operate with other SMAs in the subnet to act as a distributed SM. In some embodiments, SMA 476 includes or executes on standalone circuitry and logic, such as a microcontroller, single core processor, or multi-core processor. In other embodiments, SMA 476 is implemented via software and/or firmware instructions executed on a processor core or other processing element that is part of a processor or other processing element used to implement packet processing and switching logic 478.

Embodiments are not specifically limited to implementations including multi-port IB interfaces 460A-460D. In one embodiment, ports are associated with their own receive and transmit buffers, with the crossbar 482 being configured to interconnect those buffers with receive queues 472 and transmit queues 474 in the memory 470. Packet processing and switching is then primarily performed by the packet processing and switching logic 478 of the core switch logic 480.

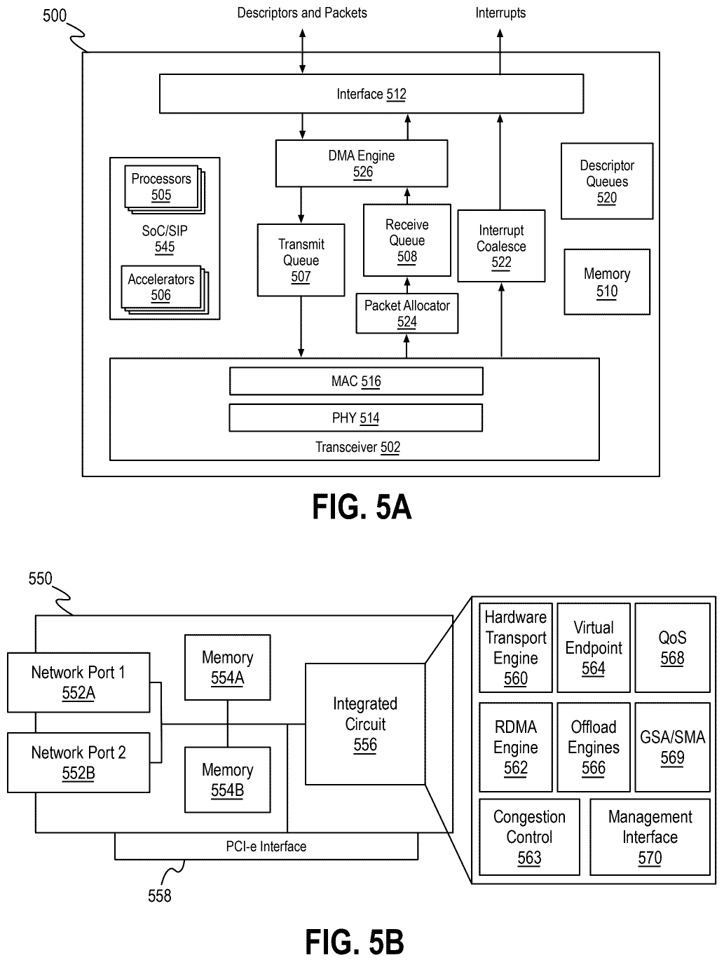

FIGS. 5A-5B depict example network interface devices. In implementations herein, the example network interface devices of FIGS. 5A-5B may include components to implement stateful flow table management using programmable network interface devices, in accordance with the discussion below with respect to FIGS. 8-14. FIG. 5A illustrates a network interface device 500 that may be configured as a smart Ethernet device. FIG. 5B illustrates a network interface device 550 which may be configured as an InfiniBand channel adapter.

As shown in FIG. 5A, in one configuration, the network interface device 500 can include a transceiver 502, transmit queue 507, receive queue 508, memory 510, and bus interface 512, and DMA engine 526. The network interface device 500 can also include an SoC/SiP 545, which includes processors 505 to implement smart network interface device functionality, as well as accelerators 506 for various accelerated functionality, such as NVMe-oF or RDMA. The specific makeup of the network interface device 500 depends on the protocol implemented via the network interface device 500.

In various configurations, the network interface device 500 is configurable to interface with networks including but not limited to Ethernet, including Ultra Ethernet. However, the network interface device 500 may also be configured as an InfiniBand or NVLink interface via the modification of various components. For example, the transceiver 502 can be capable of receiving and transmitting packets in conformance with the InfiniBand, Ethernet, or NVLink protocols. Other protocols may also be used. The transceiver 502 can receive and transmit packets from and to a network via a network medium. The transceiver 502 can include PHY circuitry 514 and media access control circuitry (MAC circuitry 516). PHY circuitry 514 can include encoding and decoding circuitry to encode and decode data packets according to applicable physical layer specifications or standards. MAC circuitry 516 can be configured to assemble data to be transmitted into packets, that include destination and source addresses along with network control information and error detection hash values.

The SoC/SiP 545 can include processors that may be any a combination of a CPU processor, graphics processing unit (GPU), field programmable gate array (FPGA), application specific integrated circuit (ASIC), or other programmable hardware device that allow programming of network interface device 500. For example, a smart network interface can provide packet processing capabilities in the network interface using processors 505. Configuration of operation of processors 505, including programmable data plane processors, can be programmed using Programming Protocol-independent Packet Processors (P4), C, Python, Broadcom Network Programming Language (NPL), x86, or ARM compatible executable binaries or other executable binaries.

The packet allocator 524 can provide distribution of received packets for processing by multiple CPUs or cores using timeslot allocation. An interrupt coalesce circuit 522 can perform interrupt moderation in which the interrupt coalesce circuit 522 waits for multiple packets to arrive, or for a time-out to expire, before generating an interrupt to host system to process received packet(s). Receive Segment Coalescing (RSC) can be performed by the network interface device 500 in which portions of incoming packets are combined into segments of a packet. The network interface device 500 can then provide this coalesced packet to an application. A DMA engine 526 can copy a packet header, packet payload, and/or descriptor directly from host memory to the network interface or vice versa, instead of copying the packet to an intermediate buffer at the host and then using another copy operation from the intermediate buffer to the destination buffer. The memory 510 can be any type of volatile or non-volatile memory device and can store any queue or instructions used to program the network interface device 500. The transmit queue 507 can include data or references to data for transmission by network interface. The receive queue 508 can include data or references to data that was received by network interface from a network. The descriptor queues 520 can include descriptors that reference data or packets in transmit queue 507 or receive queue 508. The bus interface 512 can provide an interface with host device. For example, the bus interface 512 can be compatible with PCI Express, although other interconnection standards may be used.

As shown in FIG. 5B, a network interface device 550 can be configured as an implementation of the network interface device 500 to implement an InfiniBand HCA. The network interface device 550 includes network ports 552A-552B, memory 554A-554B, a PCIe interface 558 and an integrated circuit 556 that includes hardware, firmware, and/or software to implement, manage, and/or control HCA functionality. In one implementation, the integrated circuit includes a hardware transport engine 560, an RDMA engine 562, congestion control logic 563, virtual endpoint logic 564, offload engines 566, QoS logic 568, GSA/SMA logic 569, and a management interface. Different implementations of the network interface device 550 may include additional components or may exclude some components. A network interface device 550 configured as a TCA will include some implementation specific subset of the functionality of an HCA. The integrated circuit 556 includes programmable and fixed function hardware to implement the described functionality.

While the illustrated implementation of the network interface device 550 is shown as having a PCIe interface 558, other implementations can use other interfaces. For example, the network interface device 550 may use an Open Compute Project (OCP) mezzanine connector. Additionally, the PCIe interface 558 may also be configured with a multi-host solution that enables multiple compute or storage hosts to couple with the network interface device 550. The PCIe interface 558 may also support technology that enables direct PCIe access to multiple CPU sockets, which eliminates the network traffic having to traverse the inter-processor bus of a multi-socket server motherboard for a server that includes the network interface device 550.

The network interface device 550 implements endpoint elements of the InfiniBand architecture, which is based around queue pairs and RDMA. InfiniBand off-loads traffic control from software through the use of execution queues (e.g., work queues), which are initiated by a software client and managed in hardware. Communication endpoints includes a queue pair (QP) having a send queue and a receive queue. A QP is a memory-based abstraction where communication is achieved between memory-to-memory transfers between applications or between applications and devices. Communication to QPs occurs through virtual lanes of the network ports 552A-552B, which enable multiple independent data flows to share the same link, with separate buffering and flow control for respective flows.

Communication occurs via channel I/O, in which a virtual channel directly connects two applications that exist in separate address spaces. The hardware transport engine 560 includes hardware logic to perform transport level operations via the QP for an endpoint. The RDMA engine 562 leverages the hardware transport engine 560 to perform RDMA operations between endpoints. The RDMA engine 562 implements RDMA operations in hardware and enables an application to read and write the memory of a remote system without OS kernel intervention or unnecessary data copies by allowing one endpoint of a communication channel to place information directly into the memory of another endpoint. The virtual endpoint logic 564 manages the operation of a virtual endpoint for channel I/O, which is a virtual instance of a QP that will be used by an application. The virtual endpoint logic 564 maps the QPs into the virtual address space of an application associated with a virtual endpoint.

Congestion control logic 563 performs operations to mitigate the occurrence of congestion on a channel. In various implementations, the congestion control logic 563 can perform flow control over a channel to limit congestion at the destination of a data transfer. The congestion control logic 563 can perform link level flow control to manage congestion at source congestion at virtual links of the network ports 552A-552B. In some implementations, the congestion control logic can perform operations to limit congestion at intermediate points (e.g., IB switches) along a channel.

Offload engines 566 enable the offload of network tasks that may otherwise be performed in software to the network interface device 550. The offload engines 566 can support offload of operations including but not limited to offload of receive side scaling from a device driver or stateless network operations, for example, for TCP implementations over InfiniBand, such as TCP/UDP/IP stateless offload or Virtual Extensible Local Area Network (VXLAN) offload. The offload engines 566 can also implement operations of an interrupt coalesce circuit 522 of the network interface device 500 of FIG. 5A. The offload engines 566 can also be configured to support offload of NVME-oF or other storage acceleration operations from a CPU.

The QoS logic 568 can perform QoS operations, including QoS functionality that is within the basic service delivery mechanism of InfiniBand. The QoS logic 568 can also implement enhanced InfiniBand QoS, such as fine grained end-to-end QoS. The QoS logic 568 can implement queuing services and management for prioritizing flows and guaranteeing service levels or bandwidth according to flow priority. For example, the QoS logic 568 can configure virtual lane arbitration for virtual lanes of the network ports 552A-552B according to flow priority. The QoS logic 568 can also operate in concert with the congestion control logic 563.

The GSA/SMA logic 569 implements general services agent (GSA) operations to manage the network interface device 550 and the InfiniBand fabric, as well as performing subnet management agent operations. The GSA operations include device-specific management tasks, such as querying device attributes, configuring device settings, and controlling device behavior. The GSA/SMA logic 569 can also implement SMA operations, including a subset of the operations performed by the SMA 476 of the InfiniBand switch 450 of FIG. 4C. For example, the GSA/SMA logic 569 can handle management requests from the subnet manager, including device reset requests, firmware update requests, or requests to modify configuration parameters.

The management interface 570 provides support for a hardware interface to perform out-of-band management of the network interface device 550, such as an interconnect to a board management controller (BMC) or a hardware debug interface.

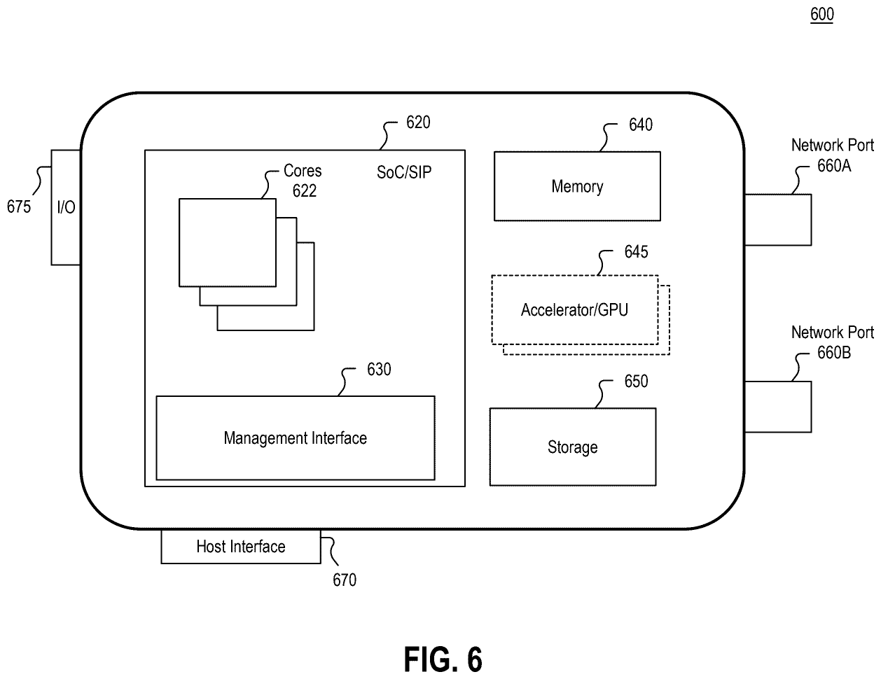

FIG. 6 is a block diagram illustrating a programmable network interface 600 and data processing unit. In implementations herein, the example programmable network interface 600 and data processing unit of FIG. 6 may implement stateful flow table management using programmable network interface devices, in accordance with the discussion below with respect to FIGS. 8-14. The programmable network interface 600 is a programmable network engine that can be used to accelerate network-based compute tasks within a distributed environment. The programmable network interface 600 can couple with a host system via host interface 670. The programmable network interface 600 can be used to accelerate network or storage operations for CPUs or GPUs of the host system. The host system can be, for example, a node of a distributed learning system used to perform distributed training, for example, as shown in FIG. 6. The host system can also be a data center node within a data center.

In one embodiment, access to remote storage containing model data can be accelerated by the programmable network interface 600. For example, the programmable network interface 600 can be configured to present remote storage devices as local storage devices to the host system. The programmable network interface 600 can also accelerate RDMA operations performed between GPUs of the host system with GPUs of remote systems. In one embodiment, the programmable network interface 600 can enable storage functionality such as, but not limited to NVME-OF. The programmable network interface 600 can also accelerate encryption, data integrity, compression, and other operations for remote storage on behalf of the host system, allowing remote storage to approach the latencies of storage devices that are directly attached to the host system.

The programmable network interface 600 can also perform resource allocation and management on behalf of the host system. Storage security operations can be offloaded to the programmable network interface 600 and performed in concert with the allocation and management of remote storage resources. Network-based operations to manage access to the remote storage that would otherwise by performed by a processor of the host system can instead be performed by the programmable network interface 600.

In one embodiment, network and/or data security operations can be offloaded from the host system to the programmable network interface 600. Data center security policies for a data center node can be handled by the programmable network interface 600 instead of the processors of the host system. For example, the programmable network interface 600 can detect and mitigate against an attempted network-based attack (e.g., DDoS) on the host system, preventing the attack from compromising the availability of the host system.

The programmable network interface 600 can include a system on a chip (SoC/SiP 620) that executes an operating system via multiple processor cores 622. The processor cores 622 can include general-purpose processor (e.g., CPU) cores. In one embodiment the processor cores 622 can also include one or more GPU cores. The SoC/SiP 620 can execute instructions stored in a memory device 640. A storage device 650 can store local operating system data. The storage device 650 and memory device 640 can also be used to cache remote data for the host system. Network ports 660A-660B enable a connection to a network or fabric and facilitate network access for the SoC/SiP 620 and, via the host interface 670, for the host system. In one configuration, a first network port 660A can connect to a first forwarding element, while a second network port 660B can connect to a second forwarding element. Alternatively, both network ports 660A-660B can be connected to a single forwarding element using a link aggregation protocol (LAG). The programmable network interface 600 can also include an I/O interface 675, such as a Universal Serial Bus (USB) interface. The I/O interface 675 can be used to couple external devices to the programmable network interface 600 or as a debug interface. The programmable network interface 600 also includes a management interface 630 that enables software on the host device to manage and configure the programmable network interface 600 and/or SoC/SiP 620. In one embodiment the programmable network interface 600 may also include one or more accelerators or GPUs 645 to accept offload of parallel compute tasks from the SoC/SiP 620, host system, or remote systems coupled via the network ports 660A-660B. For example, the programmable network interface 600 can be configured with a graphics processor and participate in general-purpose or graphics compute operations in a datacenter environment.

One or more aspects may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

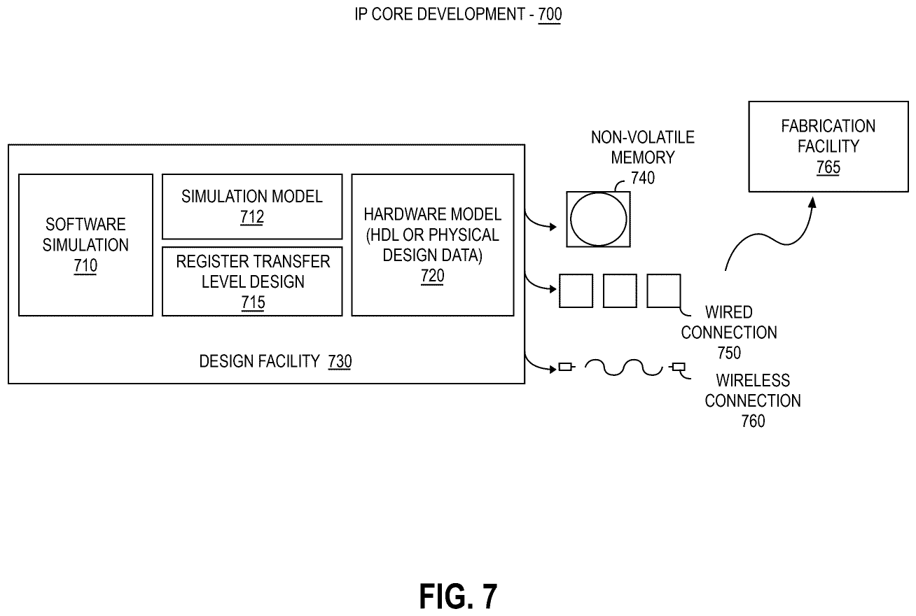

FIG. 7 is a block diagram illustrating an IP core development system 700. The IP core development system 700 may be used to manufacture an integrated circuit to perform operations of fabric and datacenter components described herein. In implementations herein, the example IP core development system 700 of FIG. 7 may manufacture an integrated circuit that implements stateful flow table management using programmable network interface devices, in accordance with the discussion below with respect to FIGS. 8-14. The IP core development system 700 may be used to generate modular, re-usable designs that can be incorporated into a larger design or used to construct an entire integrated circuit (e.g., an SOC integrated circuit). A design facility 730 can generate a software simulation 710 of an IP core design in a high-level programming language (e.g., C/C++). The software simulation 710 can be used to design, test, and verify the behavior of the IP core using a simulation model 712. The simulation model 712 may include functional, behavioral, and/or timing simulations. A register transfer level design (RTL design 715) can then be created or synthesized from the simulation model 712. The RTL design 715 is an abstraction of the behavior of the integrated circuit that models the flow of digital signals between hardware registers, including the associated logic performed using the modeled digital signals. In addition to an RTL design 715, lower-level designs at the logic level or transistor level may also be created, designed, or synthesized. Thus, the particular details of the initial design and simulation may vary.

The RTL design 715 or equivalent may be further synthesized by the design facility into a hardware model 720, which may be in a hardware description language (HDL), or some other representation of physical design data. The HDL may be further simulated or tested to verify the IP core design. The IP core design can be stored for delivery to a fabrication facility 765 using non-volatile memory 740 (e.g., hard disk, flash memory, or any non-volatile storage medium). The fabrication facility 765 may be a 3rd party fabrication facility. Alternatively, the IP core design may be transmitted (e.g., via the Internet) over a wired connection 750 or wireless connection 760. The fabrication facility 765 may then fabricate an integrated circuit that is based at least in part on the IP core design. The fabricated integrated circuit can be configured to perform operations in accordance with at least one embodiment described herein.

### Stateful Flow Table Management Using Programmable Network Interface Devices

In highly virtualized environments, significant amounts of server resources are expended for processing tasks that are beyond user applications. Such processing tasks can include hypervisors, container engines, network and storage functions, security, and large amounts of network traffic. To address these various processing tasks, programmable network interface devices with accelerators and network connectivity have been introduced. These programmable network interface devices are referred to as infrastructure processing units (IPUs), data processing units (DPUs), edge processing units (EPUs), advanced network interface devices, programmable packet processing devices, and so on.

The programmable network interface devices can accelerate and manage infrastructure functions using dedicated and programmable cores deployed in the devices. The programmable network interface devices can provide for infrastructure offload and an extra layer of security by serving as a control point of the host for running infrastructure applications. By using programmable network interface devices, the overhead associated with running infrastructure tasks can be offloaded from a server device.

In implementations herein, the programmable network interface devices may be referred to generally as a programmable network interface device (PNID), a network interface device, an advanced network interface device, an IPU, or a DPU, an EPU, or a programable packet processing device, for example. For the discussion herein, the programmable network interface device will be referred to in abbreviated form as PNID.

In computing ecosystems utilizing PNIDs, data packets (e.g., network packets) can be transmitted between computing devices, such as PNIDs, and/or device components at a rapid pace. Depending on the specific purpose of the received data packets, the receiving device processes the data packet in a certain way. Accordingly, the received data packets are categorized or otherwise classified according to “flows” that define operations and/or other rules for the processing of the received packets. A variety of mechanisms have been employed to increase the speed at which such packet classifications occur.

Flow tables are used to store rules for the “flows” the define the operations and/or other rules for processing of the received packets. These rules are referred to herein as flow rules. Flow tables contain flows that are used to perform packet lookup, modification, and forwarding. In some implementations, the flows may have a key, which is used in order to classify the packet into a certain flow. A computing device, such as a PNID, can be configured to read/generate a key based on a set of fields read from a received data packet and determine a traffic flow by which to handle the data packet based on the read/generated key.

In some cases, large (e.g., approximately 100M entry) flow tables have increasingly become an occurrence in data centers. Implementing large flow tables in software and/or using general-purpose CPUs for such implementation can result in reduced lookup speed and performance. A hardware offload of large flow tables would be beneficial in terms of classification and throughput performance. On the other hand, offloading large flow tables to hardware can result in the hardware having to implement an aging scheme for the flow table at scale. Implementing an aging scheme, especially at scale, can utilize large amounts of state (i.e., die area).

Implementations herein provide for stateful flow table management using programmable network interface devices. Implementations herein aim to achieve a balance between obtaining improved performance while maintaining reasonable hardware area cost.

Some implementations herein provide for a hybrid hardware and software approach for providing a flow table. In the hybrid approach, the flow table is implemented in hardware of a PNID, while using a control plane provided by programmable circuitry of the PNID for implementing an aging scheme for the flow table. Implementations herein provide for a variety of different approaches to implement aging in software of the PNID. A one example first approach is to maintain state and timer for individual flows of the hardware flow table in the control plane and route individual data packets to software to update the state. If the timer expires for any flow, then the entry is deleted in the hardware flow table. In an example second approach, a packet counter is maintained in hardware that the control plane can access and/or monitor. The counter is periodically polled to determine if there is any activity for the flows. If there has been no activity for the timer duration, then the corresponding flow entry is deleted in the hardware flow table. Other approaches may also be implemented by embodiments herein.

Some implementations provide for a full software approach for providing a flow table. In the full software approach of implementations herein, a multi-threaded software flow table is implemented using programmable circuitry of the PNID. The multi-threaded software flow table is configured for flow lookup as well as flow add and flow update performance.

In some implementations, depending on the particular approach that is implemented, embodiments may provide for an improved hardware storage footprint, improved throughput rate, improved on-die area consumption, and/or improved connections per second (CPS) rate of the system. Further details on the implementations of providing stateful flow table management using programmable network interface devices are described below with respect to FIGS. 8-14.

FIG. 8 is a block diagram illustrating an example computing environment 800 for providing for stateful flow table management using programmable network interface devices, according to implementations herein. In one implementation, the computing environment 800 that may include various clusters (e.g., 840A-C) of processing units 845A-845C (e.g., GPUs, Tensor Flow processors, other types of accelerators, etc.). A cluster 840 may also include one or more PNIDs 850 to facilitate communication between the processing units 845 and network 830. Network 830 may further be coupled to various storage devices 820A-C and orchestrator 810.

The elements of FIG. 8 having the same or similar names as the elements of any other figure herein describe the same elements as in the other figures, can operate or function in a manner similar to that, can comprise the same components, and can be linked to other entities, as those described elsewhere herein, but are not limited to such. Therefore, the discussion of any features in combination with a graphics processor herein also discloses a corresponding combination with the example computing environment 800, but is not limited to such.

In various embodiments, components of computing environment 800 (including requesting, target, and/or consuming devices) may be coupled together through one or more networks (e.g., network) comprising any number of intervening network nodes, such as routers, switches, or other computing devices. The network, the requesting device, and/or the target device may be part of any suitable network topography, such as a data center network, a wide area network, a local area network, an edge network, or an enterprise network.

The storage command may be communicated from the requesting device to the target device and/or data read responsive to a storage command may be communicated from the target device to the consuming device over any suitable communication protocol (or multiple protocols), such as peripheral component interconnect (PCI), PCI Express (PCie), CXL, Universal Serial Bus (USB), Serial Attached SCSI (SAS), Serial ATA (SATA), InfiniBand, Fibre Channel (FC), IEEE 802.3, IEEE 802.11, Ultra Ethernet, or other current or future signaling protocol. The storage command may include, but is not limited to, commands to write data, read data, and/or erase data, for example. In particular embodiments, the storage commands conform with a logical device interface specification (also referred to herein as a network communication protocol) such as Non-Volatile Memory Express (NVMe) or Advanced Host Controller Interface (AHCI), for example.

A computing platform, such as computing environment 800, may include one or more requesting devices, consuming devices, and/or target devices. Such devices may comprise one or more processing units (e.g., processing units 845) to generate a storage command, decode and process a storage command, and/or consume (e.g., process) data requested by a storage command. As used herein, the terms “processor unit”, “processing unit”, “processor”, or “processing element”, may refer to any device or portion of a device that processes electronic data from registers and/or memory to transform that electronic data into other electronic data that may be stored in registers and/or memory.

A processing unit may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), edge processing units (EPUs), vector processing units, software defined processing units, video processing units, data processor units (DPUs), memory processing units, storage processing units, accelerators (e.g., graphics accelerator, compression accelerator, artificial intelligence accelerator, networking accelerator), controller cryptoprocessors (specialized processors that execute cryptographic algorithms within hardware), server processors, I/O controllers, NICs (e.g., SmartNICs), infrastructure processing units (IPUs), microcode engines, memory controllers (e.g., cache controllers, host memory controllers, DRAM controllers, SSD controllers, hard disk drive (HDD) controllers, nonvolatile memory controllers, etc.), or any other suitable type of processor units. As such, a processor unit may be referred to as an XPU.

Components of computing environment 800 may have any suitable characteristics of similar components of those described with respect to FIGS. 5A-5B and 6. For example, computing environment 800 may be, e.g., an Ethernet, Ultra Ethernet, CXL, a network using a proprietary network protocol, or other suitable network, utilizing the network interface device 500, 550 of FIGS. 5A-5B herein or programmable network interface 600 of FIG. 6.

In some embodiments, computing environment 800 may be a data center or other similar environment, where any combination of the components may be placed together in a rack or shared in a data center pod. In various embodiments, computing environment 800 may represent a telecom environment, in which any combination of the components may be enclosed together in curb/street furniture or an enterprise wiring closet.

In some embodiments, orchestrator 810 may function as a requesting device and send storage commands as described herein to storage devices 820A-C functioning as target devices. Some of these commands may read data that is then supplied to processing units 845 that are functioning as consuming devices. In some embodiments, a processing unit 845 or an PNID 850 may function as the requesting device. Thus, a processing unit 845 could be both a requesting device and the consuming device. In one implementation, PNID 850 may be the same as network interface device 500, 550 of FIGS. 5A-5B herein or programmable network interface 600 and data processing unit of FIG. 6 herein, and can be referred to as an IPU or a DPU, for example.

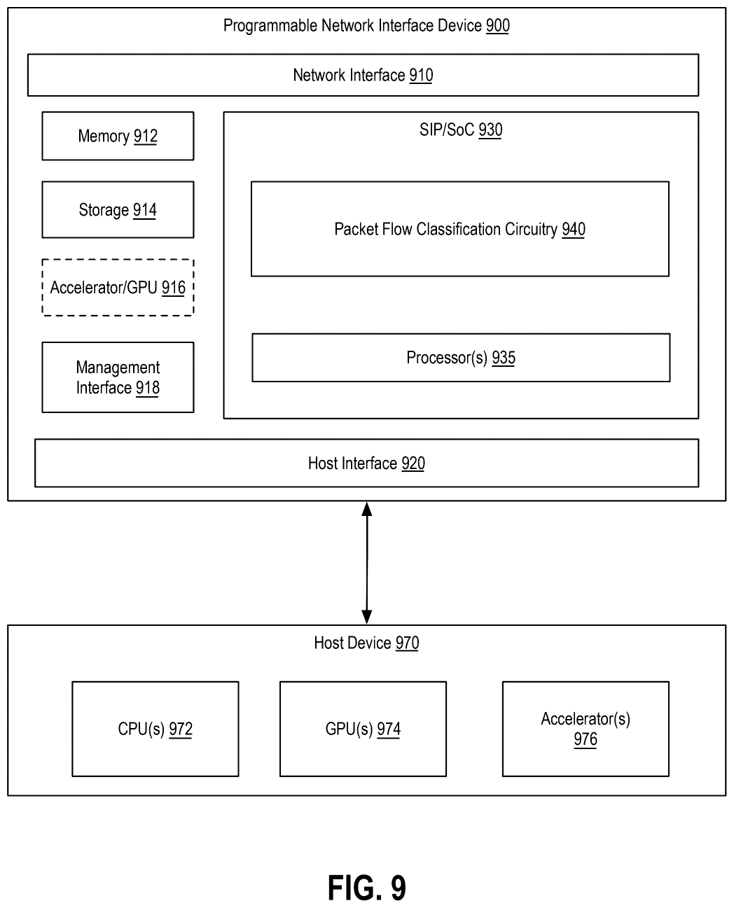

As previously discussed, the PNID 850 in implementations herein is configured to provide for stateful flow table management using programmable network interface devices, a further discussed with respect to FIGS. 9-14 below.

FIG. 9 is a block diagram of an example PNID 900 for providing stateful flow table management using programmable network interface devices, in accordance with implementations herein. In one implementation, PNID 900 may be the same as PNID 850 described with respect to FIG. 8. In some implementations, PNID 900 may be the same as network interface device 500, 550 of FIGS. 5A-5B herein and/or programmable network interface 600 and data processing unit of FIG. 6 herein, and may be referred to as an IPU or a DPU in some examples.

In one configuration, the PNID 900 can include a network interface 910, memory 912, storage 914, an accelerator/GPU 916, a host interface 920, and a SIP/SoC 930. The management interface 918 can provide a dedicated management complex for the PNID 900, where the management interface 918 includes one or more processors, such as programmable circuitry, and subsystems to provide secure boot, maintenance, and upgrades. In some implementations, the SIP/SoC 930 utilizes processors 935 to implement smart network interface device functionality. For example, the processors 935 may include CPUs, GPUs, and/or accelerators for various functionality, such as NVMe-oF or RDMA. The specific makeup of the PNID 900 depends on the protocol implemented via the PNID 900.

In various configurations, the PNID 900 is configurable to interface with networks including but not limited to InfiniBand, Ethernet, or NVLink. The accelerator/GPU 916 and/or processor(s) 935 can include processors that may be any a combination of a CPU processor, graphics processing unit (GPU), field programmable gate array (FPGA), application specific integrated circuit (ASIC), or other programmable hardware device that allow programming of ANID P00. For example, a smart network interface can provide packet processing capabilities in the network interface using processors. Configuration of operations of the PNID 900, including programmable data plane processors, can be programmed using Programming Protocol-independent Packet Processors (P4), C, Python, Broadcom Network Programming Language (NPL), x86, or ARM compatible executable binaries or other executable binaries.

In some implementations, PNID 900 may be communicably coupled (e.g., over a network) to a host device, such as host device 970, via host interface 920 In one implementation, the host device 970 may be the same as one of processing units 845 described with respect to FIG. 8. The host device 970 may include one or more CPU(s) 972, GPU(s) 974, and/or accelerator(s) 976 to perform various processing tasks.

As previously discussed, datacenters that utilize PNIDs, such as PNID 900, may receive and process data packets (e.g., network packets) that are transmitted between computing devices, such as to and/or from host device 970. The PNID 900 may implement packet flow classification circuitry 940 to classify and process the data packet in a certain way. In some implementations, the packet flow classification circuitry 940 can categorized or otherwise classify the data packets according to “flows” that define operations and/or other rules for the processing of the received packets. The packet flow classification circuitry 940 may rely on flow tables to store rules for the “flows” that define the operations and/or other rules for processing of the received packets. These rules are referred to herein as flow rules. Flow tables contain flows that are used to perform packet lookup, modification, and forwarding. In some implementations, the individual flows may have a key, which is used in order to classify the packet into a certain flow. The packet flow classification circuitry 940 can be configured to read/generate a key based on a set of fields read from a received data packet and determine a traffic flow by which to handle the data packet based on the read/generated key.

Implementations herein provide for stateful flow table management using packet flow classification circuitry 940 of PNID 900. In one implementation, a hybrid hardware and software approach for providing a flow table is described. In the hybrid approach, the flow table is implemented in hardware of a PNID, while using a control plane provided by the programmable circuitry of the PNID for implementing an aging scheme for the hardware flow table.

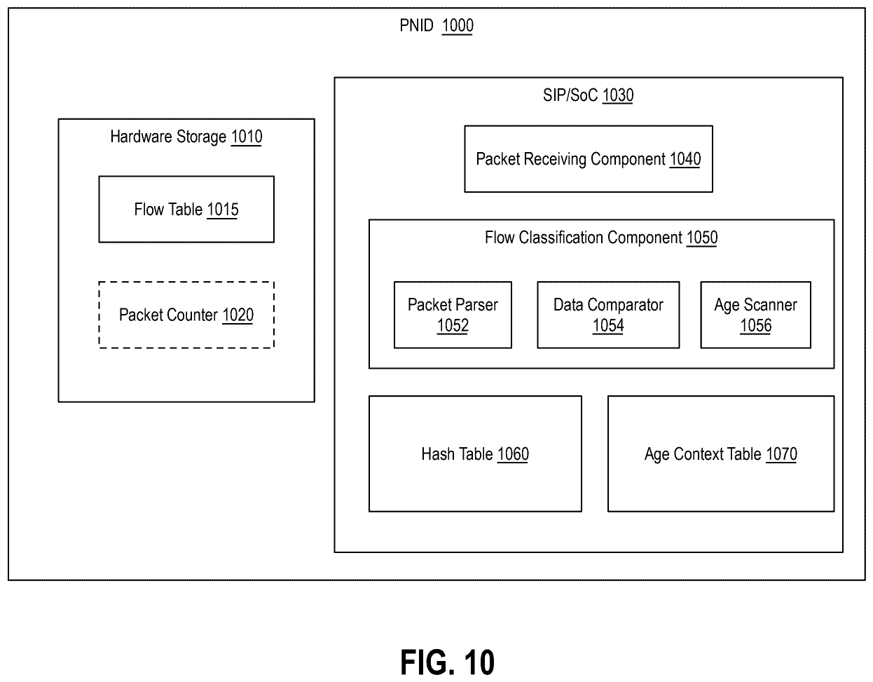

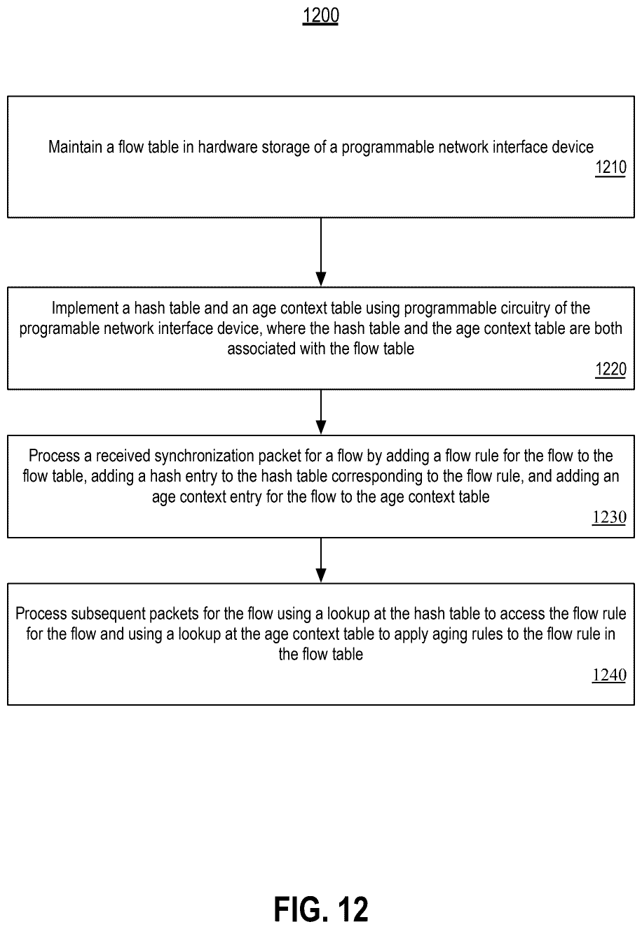

Implementations herein provide for at least two different approaches to implement aging for individual flows of a hardware flow table in software of the PNID. A first approach is to maintain state and timer for the individual flows in the control plane and route received data packets to software to update the corresponding flow state. If the timer expires for any flow, then the entry is deleted in the hardware flow table. Further details of this first hybrid software/hardware approach for flow table management are described below with respect to FIG. 10 as well as FIG. 12.

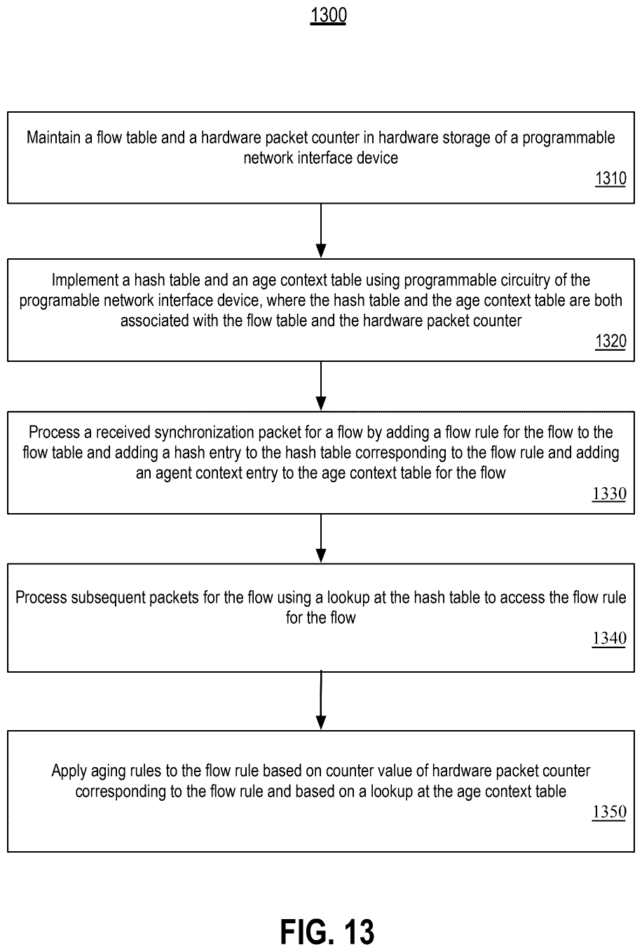

A second approach is to maintain a large-scale packet counter in hardware for the flows that the control plane can access and/or monitor. The counter is periodically polled to determine if there is any activity with regard to the flows of the hardware flow table. If there has been no activity for the timer duration, then the entry for the corresponding flow is deleted in the hardware flow table. Further details of this second hybrid software/hardware approach for flow table management are described below with respect to FIG. 10 as well as FIG. 13.

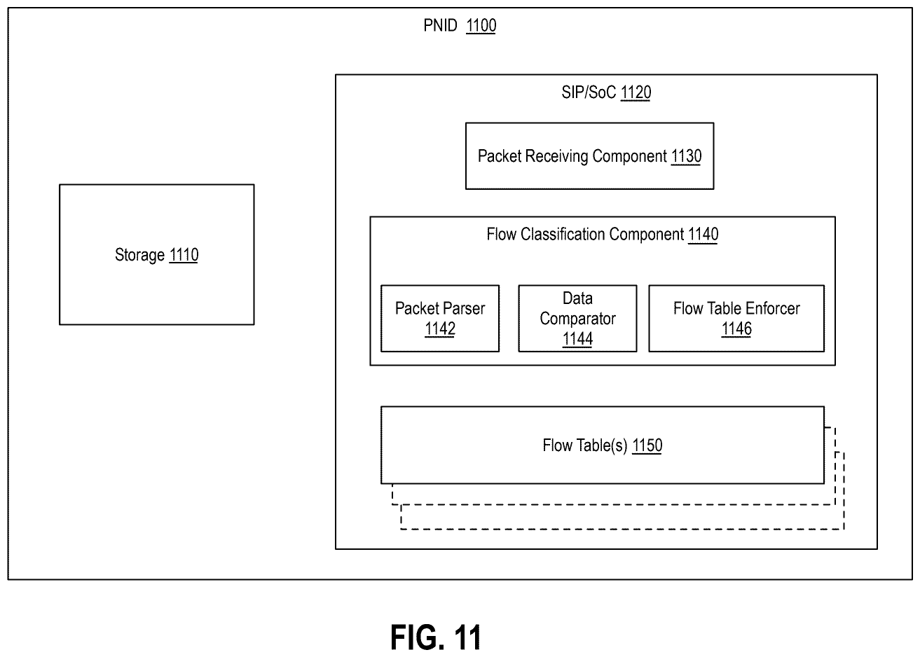

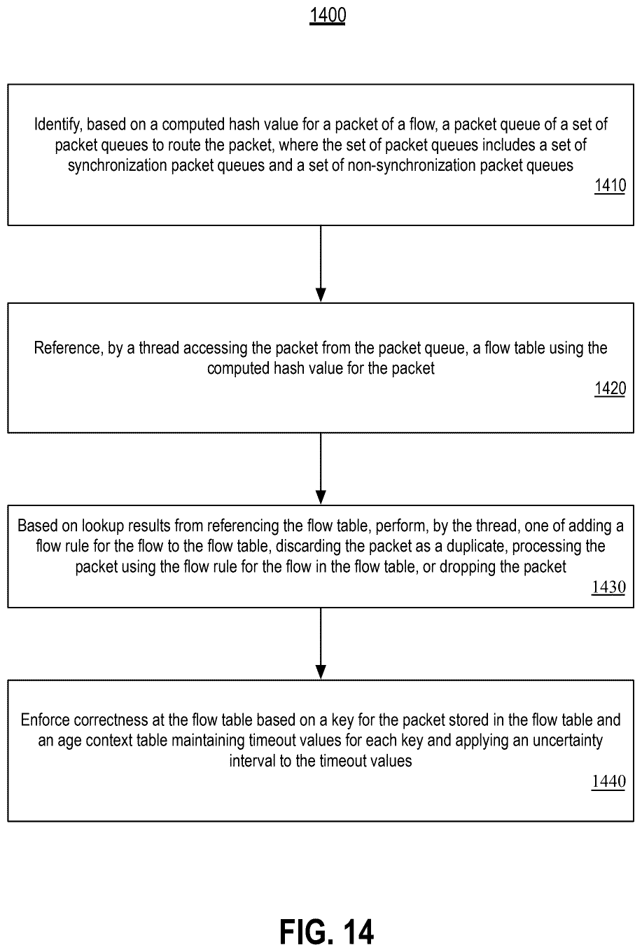

Implementations further provide for a full software approach for providing a flow table. In the full software approach of implementations herein, a multi-threaded software flow table is implemented using programmable circuitry of the PNID. The multi-threaded software flow table is configured for flow lookup as well as flow add/update performance. Further details of this full software approach for flow table management are described below with respect to FIG. 11 as well as FIG. 14.

FIG. 10 is a block diagram of an example PNID 1000 for providing a hybrid software/hardware approach for stateful flow table management using programmable network interface devices, in accordance with implementations herein. In one implementation, PNID 1000 may be the same as PNID 900 described with respect to FIG. 9. In some implementations, PNID 1000 may be the same as network interface device 500, 550 of FIGS. 5A-5B herein and/or programmable network interface 600 and data processing unit of FIG. 6 herein, and may be referred to as an IPU or a DPU in some examples.

As shown in FIG. 10, PNID 1000 may include hardware storage 1010 and SIP/SoC 1030. Storage 1010 may be embodied as any type of device or devices configured for short-term or long-term storage of data such as, for example, hard disk drives, solid-state drives, or other hardware data storage devices. In some implementations, the hardware storage 1010 may include double data rate synchronous dynamic random access memory (DDR-SRAM), for example. In one implementation, hardware storage 1010 may be the same as storage 914 described with respect to FIG. 9.

In one implementation, SIP/SoC 1030 may be the same as SIP/SoC 930 described with respect to FIG. 9. SIP/SoC 1030 may include programmable hardware circuitry that can implement a packet receiving component 1040, a flow classification component 1050, a hash table 1060, and/or an age context table 1070.

In one implementation, the PNID 1000 may implement a hybrid approach to providing stateful flow table management. In the hybrid approach, the flow table 1015 is implemented in hardware, such as hardware storage 1010 of the PNID 1000, while using a control plane provided by the SIP/SoC 1030 of the PNID 1000 for implementing an aging scheme.

As part of the hybrid approach, the SIP/SoC 1030 may perform data packet flow classification by executing a packet processing pipeline (e.g., sequence of processes). As part of the packet processing pipeline, the packet receiving component 1040 may receive a burst of data packets (e.g., network packets) and nonlinearly process the burst of packets (e.g., in pairs of packets) via out-of-order execution. The packet receiving component 1040 may pass the received packets to the flow classification component 1050 to map the incoming data packets against known traffic flows (e.g., network traffic flows). In the hybrid approach, processing of data packets is shared between the hardware and software of the PNID 1000. Such shared processing can refer to, for example, how and when flows are added to the flow table 1015, what occurs when subsequent flow data packets arrive and how they get mapped to an existing flow rule, who handles packets, and so on.

Generally, the flow classification component 1050 implements the packet parser 1052 to determine a key associated with a received data packet based on a set of packet fields of the received data packet (e.g., a specific n-tuple of fields from the packet header) and generates/reads a key signature for the determined key. The flow classification component 1050 implements the data comparator 1054 to apply (e.g., compare) the key signature to one or more of a hash table 1060 and the flow table 1015 to identify and/or add a flow rule associated with the key signature.

In the hybrid approach described herein, two tables may be maintained by the SIP/SoC 1030 programmable circuitry: the hash table 1060 and the age context table 1070. Furthermore, the flow table 1015 is maintained in hardware storage 1010, such as DDR. In one implementation, the hardware storage 1010 may utilize a hash scheme, such as a cuckoo-based hash scheme, to lookup entries in the flow table 1015. A flow table 1015 entry may include, but is not limited to, header files for matching purposes with the entries including a specific value or a wildcard that could match all entries, matching packet counters that are used for statistical purposes, and actions that specify the manner in which to handle the packets of a flow which can be any of the following: forwarding the packet, dropping the packet, forwarding the packet to a controller, modifying the virtual local area network (VLAN), VLAN priority (PCP), and/or stripping the VLAN header. In some implementations, the flow table 1015 entry may further include an additional metadata control value (set_metadata action) that can store a software flow identifier (SW flow_id). This can be used to index into the age context table 1070.

In implementations herein, when implementing the hybrid approach, a first initial packet for a flow, often referred to as a synchronization (SYN) packet, is forwarded to the flow classification component 1050. The flow classification component 1050 processes the SYN packet, applies actions, and reinjects packet into packet processing pipeline. In addition, the flow classification component 1050 may also install a flow rule for the flow of the SYN packet in the hardware-offloaded flow table 1015. This flow rule then applies to all subsequent (e.g., non-SYN) packets for that flow.

As part of processing the SYN packet, the packet classification component 1050 uses the hash table 1060 to manage SYN packet flows, such as adding new SYN packet flows, handling duplicate SYN packets, and so on. Once a flow is established, there are no further SYN packets for a flow. When a new SYN packet is received, the packet classification component 1050 checks whether there is already a SYN packet flow in the hash table 1060. If a duplicate SYN packet is in the hash table 1060, then the SYN packet is dropped. If a SYN packet flow is not in the hash table 1060, then the flow classification component 1050 adds an entry to the hash table 1060. The entry in the hash table 1060 may include a key and a timestamp. In one example implementation, the key may be 24B and the timestamp may be 4B. The flow classification component 1050 then also installs the flow rule for the flow of the SYN packet in the flow table 1015 in hardware storage 1010.

Implementations herein provide for two different approaches to implement aging by the flow classification component 1050. A first approach is to maintain a state and timer for the individual flows in the control plane provided by the flow classification component 1050 and route the data packets to the flow classification component 1050 to update the state. If the timer expires for any flow, then the entry is deleted in the hardware flow table 1015.

For example, the flow classification component 1050 may, upon processing of a SYN packet for a flow, add an entry for the flow in the age context table 1070. The entry in the age context table 1070 may include, but is not limited to, the key, an age context state, an age context time select, and a timestamp. In one example, the age context state may be a 1B value, the age context time select may be a 1B value, and the timestamp may be a 2B value.

With respect to the age context state, the value may include 1b for valid state, 1b for hash table entry presence, and the remaining data is used to store flow state SYN, established, FIN (message termination), and so on for the flow. With respect to the age context time select value, some implementations may utilize multiple values, such as for example 6 different timeout values (e.g., TCP timeout values) measured in a determined time value duration measure (e.g., seconds). In one example, actual timeout values may be stored. In this case, if a 1B value is used for the age context time select, then actual time values of 1-128 seconds may be represented in the age context time select field. In another example, if encoding is utilized in the age context time select field having a 1B size, then 256 arbitrary values may be represented in the age context time select field.

For subsequent non-SYN packets of a flow, the flow classification component 1050 may perform an update, as follows. If the hash table 1060 entry is present, delete it from hash table 1060. In the age context table 1070, the flow classification component 1050 can update time select, if applicable, and refresh the timestamp in the age context table 1070.

In the first approach to aging in the hybrid scheme, for the received data packets, the flow classification component 1050 utilizes the age scanner 1056 to scan the age context table 1070 to determine whether there are any entries with an expired timer. If any entry is determined to have a timer expired, then the flow classification component 1050 sends a delete entry command to the hardware storage 1010 to delete the corresponding entry from the flow table 1015. The delete entry command can include the key for the flow that is stored in the age context table 1070.

A second approach to aging in the hybrid scheme is to maintain a packet counter 1020 in hardware of the hardware storage 1010. The hardware storage 1010 increments the packet counter 1020 for every packet seen. In implementations herein, the packet counter 1020 may include a valid bit and state bits. In one implementation, the state bits translate into a time select value.

In implementations herein, the control plane provided by the flow classification component 1050 can access and/or monitor this hardware packet counter 1020. The age scanner 1056 can periodically poll the packet counter 1020 to determine if there is any activity. For example, the age scanner can determine whether there are any valid packet counters 1020 that have not been incremented in the time select duration. If such valid packet counters 1020 are identified, then the flow is deleted from the hardware flow table 1015.

FIG. 11 is a block diagram of an example PNID 1100 for providing a software approach for stateful flow table management using programmable network interface devices, in accordance with implementations herein. In one implementation, PNID 1100 may be the same as PNID 900 described with respect to FIG. 9. In some implementations, PNID 1100 may be the same as network interface device 500, 550 of FIGS. 5A-5B herein and/or programmable network interface 600 and data processing unit of FIG. 6 herein, and may be referred to as an IPU or a DPU in some examples.

As shown in FIG. 11, PNID 1100 may include hardware storage 1110 and SIP/SoC 1120. Storage 1110 may be embodied as any type of device or devices configured for short-term or long-term storage of data such as, for example, hard disk drives, solid-state drives, or other hardware data storage devices. In one implementation, hardware storage 1110 may be the same as storage 914 described with respect to FIG. 9.

In one implementation, SIP/SoC 1120 may be the same as SIP/SoC 930 described with respect to FIG. 9. SIP/SoC 1120 may include programmable hardware circuitry that can implement a packet receiving component 1130, a flow classification component 1140, and a flow table 1150, for example.

In one implementation, the PNID 1100 may implement a full software approach to providing stateful flow table management. In the full software approach of implementations herein, a multi-threaded software flow table 1150 is implemented using programmable circuitry of the SIP/SoC 1120 of the PNID 1100. The multi-threaded software flow table 1150 is configured for flow lookup as well as flow add/update performance.

As part of the software approach, the SIP/SoC 1120 may perform data packet flow classification by executing a packet processing pipeline (e.g., sequence of processes). As part of the packet processing pipeline, the packet receiving component 1130 may receive a burst of data packets (e.g., network packets) and nonlinearly process the burst of packets (e.g., in pairs of packets) via out-of-order execution. The packet receiving component 1130 may pass the received packets to the flow classification component 1140 to map the incoming data packets against known traffic flows (e.g., network traffic flows). In the software approach, processing of data packets is performed using software of the PNID 1100. Such processing can refer to, for example, how and when flows are added to the flow table 1150, what occurs when subsequent flow data packets arrive and how they get mapped to an existing flow rule, who handles packets, and so on.

Generally, the flow classification component 1140 implements the packet parser 1142 to determine a key associated with a received data packet based on a set of packet fields of the received data packet (e.g., a specific n-tuple of fields from the packet header) and generates/reads a key signature for the determined key. The flow classification component 1140 implements the data comparator 1144 to apply (e.g., compare) the key signature to the flow table 1150 to identify/add a flow rule associated with the key signature.

In implementations herein, when a data packet (e.g., network packet) is received, the packet receiving component 1130 computes a hash value for the flow n-tuple, which is sent together with the packet to the flow classification component 1140 implementing the software flow table 1150. This hash value is used to decide the packet queue to write the packet to.

In some implementations, the individual processing elements (e.g., CPU cores) in the SIP/SoC 1120 may have its own packet queue where it is reading input packets from, therefore no synchronization is implemented between the processing elements to access the input packet queues. There may be a set of queues where the SYN packets are placed and another set of queues where the rest of the packets are placed. As a result, there can be a group of SYN threads (one SYN thread per SYN queue) and a group of worker threads (one worker thread per non-SYN queue).

In one implementation, the SW flow table 1150 may be a hash table organized into buckets, with the buckets having a fixed number of elements (ways) and the option to extend the buckets with a variable-length linked list of elements. The individual element can be a placeholder for a single key and its associated key data. In some implementations, the number of ways may be 4 or 8, for example. The software-based stateful flow table management of implementations herein provides for a multi-threaded implementation, timestamp-based synchronization between the SYN thread and the worker thread, and an ability to detect that parsing the bucket linked list is not utilized based on counter.

In some embodiments, the full software implementation for the flow table 1150 may be provided using at least two approaches. In a first approach, there is a single flow table 1150 that is shared by all the SYN and worker threads. In a second approach, a worker thread has its own flow table instance 1150 that is not accessed by the other worker threads.

When a thread (either SYN or worker thread) reads an input packet, it first reads the n-tuple from the packet and the hash accompanying the packet. The hash is used to identify the bucket within the flow table where the key is located. The key can either be in the flow table 1150 in that bucket (lookup hit) or not present in the flow table 1150 at all (lookup miss).

The SYN thread, on lookup miss, may run an access control list (ACL) policy lookup first to see if the flow should be added to the flow table 1150 or not. Assuming an allow result (as opposed to deny, on which case the packet is dropped and a statistics counter incremented), the SYN thread proceeds to add the flow to the table in the bucket just identified for this packet. If there is a free entry in one of the ways, the key can be added there. Otherwise the linked list of the current bucket is extended with a new element for this new flow. On lookup hit, the SYN packet is considered a SYN duplicate and discarded (with an associated statistics counter incremented).

In implementations herein, the hash can be symmetric, so that all of the subsequent packets for the connection, including both forward packets (from connection initiator to target) and reverse packets (from the target back to the connection initiator), can hit this (bidirectional) flow that is added by the SYN thread. All of the subsequent packets (non-SYN packets for the flow) are received and processed by a worker thread, not a SYN thread. The worker thread, on lookup miss, drops the packet. On lookup hit, the worker thread runs a state machine (e.g., TCP state machine for TCP packets), which includes an update of a flow aging timer associated with the state machine and sends the packet back to hardware for forwarding and transmission back to the network.

In the example use case of TCP flows, the first packet is a SYN packet, which is going to be processed by a SYN thread. In the case where the (bidirectional) flow is added for the TCP connection, all of the subsequent packets (until the connection is finished) are processed by one of the worker threads (a single worker thread; i.e. all the packets of the same flow are processed by the same worker thread, as selected by the hash of the n-tuple).

For the first approach of the full software implementation mentioned above (single flow table shared by all threads), as the n bits used for queue/thread selection (e.g., n=3 for 8 worker threads) and the N bits used for flow table bucket selection (e.g., N=25 for 32 million flow table buckets) are sourced out of the same hash value lower bits, it means that the buckets can be accessed by at most a single SYN thread and at most a single worker thread. There should not be more than one SYN thread accessing a given flow table bucket for the lifetime of the flow table 1150. Similarly, there should not be more than one worker thread accessing a given flow table bucket for the lifetime of the flow table 1150.

For the second approach of the full software implementation mentioned above (multiple flow tables with a single flow table per worker thread), the same assumptions stand as the first approach. The individual worker thread has its own flow table not shared with any other worker thread. The SYN threads know which flow table to use for the current flow based on the hash value, and the same rationale applied when describing the first approach is applicable again to conclude that at most one SYN thread is accessing any bucket of any flow table instance. Therefore, the multithreading implementation can enforce correctness of the table operation for at most one SYN thread and at most one worker thread per flow table bucket. The flow classification component 1140 implements a flow table enforcer 1146 to enforce the flow table 1150 operation correctness enforced for the multithreading operation of at most one SYN thread and at most one worker thread for any give flow table bucket. Flow table 1150 operation correctness is enforced by the flow table enforcer 1146 by implementing a set of rules and operations, as follows.

The key maintains a timeout when the key, if not explicitly rearmed before the deadline, is to expire. The key expiration takes place implicitly, i.e., by the time advancing. The key timestamp is compared against the current time and, if the key timestamp is in the past, the key is considered expired even if the key n-tuple matches.

Moreover, a delta is provided as an uncertainty interval before the real key expiration deadline (e.g., the key timestamp). As such, during the time intervale represented as {timestamp−delta, timestamp} the key is considered expired by any thread performing a key lookup operation. In other words, the key is considered expired (by a thread doing key lookup) with delta time before the real expiration deadline. In one implementation, an example delta value of 10 milliseconds (ms) may be implemented to manage the multi-threading requirements. On the other hand, when the SYN thread is determining a free way to add a new key, the SYN thread is going to look at the real timestamp value (uncorrected with the delta interval).

The delta for the uncertainly interval should be a value that can enable the SYN thread access and the worker thread access to be serialized for any given flow key. For example, for time<(deadline−delta), the worker thread can access the key; for time>deadline, the SYN thread accesses the key; for time in between deadline−delta and deadline, no thread is accessing the key and the key is left to expire naturally (e.g., the lookup thread is considering it invalid, so it will ignore it, while the add thread is considering it still valid, so it will ignore it as well).

In implementations herein, the flow table enforcer 1146 implements a rule that the SYN thread should add new keys to the bucket on lookup miss. Furthermore, the worker thread should process the keys on lookup hit. In some implementations, on lookup hit, the worker thread is making the current key permanent by temporarily setting its expiration deadline (key timestamp) to infinity (UINT64_MAX), so that it is not picked up by any SYN thread (lookup miss thread).

In some implementations, the worker thread (e.g., lookup hit thread) can do the following operations:
(i) Key release: Restore the original key expiration deadline. The key is left to naturally expire, unless hit by a subsequent lookup operation that could decide on a different operation from below.
(ii) Key re-arm: The key expiration deadline is pushed out in time (made bigger/expiration delayed).
(iii) Key data update: The data associated with the key is updated. The key is also rearmed.
(iv) Key delete: The key is deleted, so its slot becomes free and can be used by the SYN threads (lookup miss threads) to add a new key.

For worker threads, there is typically a time gap between the key lookup operation and the other operations mentioned above (i.e., key release/rearm/update/delete). This is because during this time the state machines should be run to decide the follow-up operation to be performed for the current key. As such, the key is temporarily made permanent during this time, as explained above.

FIG. 12 is a flow diagram illustrating an embodiment of a method 1200 for providing a first hybrid approach for stateful flow table management using programmable network interface devices. Method 1200 may be performed by processing logic that may comprise hardware (e.g., circuitry, dedicated logic, programmable logic, etc.), software (such as instructions run on a processing device), or a combination thereof. The process of method 1200 is illustrated in linear sequences for brevity and clarity in presentation; however, it is contemplated that any number of them can be performed in parallel, asynchronously, or in different orders. Further, for brevity, clarity, and case of understanding, many of the components and processes described with respect to FIGS. 1-11 may not be repeated or discussed hereafter. In one implementation, a PNID, such as PNID 850 of FIG. 8, PNID 900 of FIG. 9, and/or PNID 1000 of FIG. 10, may perform method 1200.

Method 1200 begins at processing block 1210 where a PNID may maintain a flow table in hardware storage of the PNID. Then, at block 1220, the PNID may implement a hash table and an age context table using programmable circuitry of the programable network interface device. In one implementation, the hash table and the age context table are both associated with the flow table.

Subsequently, at block 1230, the PNID may process a received synchronization packet for a flow by adding a flow rule for the flow to the flow table, adding a hash entry to the hash table corresponding to the flow rule, and adding an age context entry for the flow to the age context table. Lastly, at block 1240, the PNID may process subsequent packets for the flow using a lookup at the hash table to access the flow rule for the flow and using a lookup at the age context table to apply aging rules to the flow rule in the flow table.

FIG. 13 is a flow diagram illustrating an embodiment of a method 1300 for providing a second hybrid approach for stateful flow table management using programmable network interface devices. Method 1300 may be performed by processing logic that may comprise hardware (e.g., circuitry, dedicated logic, programmable logic, etc.), software (such as instructions run on a processing device), or a combination thereof. The process of method 1300 is illustrated in linear sequences for brevity and clarity in presentation; however, it is contemplated that any number of them can be performed in parallel, asynchronously, or in different orders. Further, for brevity, clarity, and case of understanding, many of the components and processes described with respect to FIGS. 1-12 may not be repeated or discussed hereafter. In one implementation, a PNID, such as PNID 850 of FIG. 8, PNID 900 of FIG. 9, and/or PNID 1000 of FIG. 10, may perform method 1300.

Method 1300 begins at processing block 1310 where a PNID may maintain a flow table and a hardware packet counter in hardware storage of the PNID. Then, at block 1320, the PNID may implement a hash table and an age context table using programmable circuitry of the programable network interface device. In one implementation, the hash table and the age context table are both associated with the flow table and the hardware packet counter.

Subsequently, at block 1330, the PNID may process a received synchronization packet for a flow by adding a flow rule for the flow to the flow table and adding a hash entry to the hash table corresponding to the flow rule and adding an agent context entry to the age context table for the flow. At block 1340, the PNID may process subsequent packets for the flow using a lookup at the hash table to access the flow rule for the flow. Lastly, at block 1350, the PNID may apply aging rules to the flow rule based on counter value of hardware packet counter corresponding to the flow rule and based on a lookup at the age context table.

FIG. 14 is a flow diagram illustrating an embodiment of a method 1400 providing a software approach for stateful flow table management using programmable network interface devices. Method 1400 may be performed by processing logic that may comprise hardware (e.g., circuitry, dedicated logic, programmable logic, etc.), software (such as instructions run on a processing device), or a combination thereof. The process of method 1400 is illustrated in linear sequences for brevity and clarity in presentation; however, it is contemplated that any number of them can be performed in parallel, asynchronously, or in different orders. Further, for brevity, clarity, and case of understanding, many of the components and processes described with respect to FIGS. 1-12 may not be repeated or discussed hereafter. In one implementation, a PNID, such as PNID 850 of FIG. 8, PNID 900 of FIG. 9, and/or PNID 1100 of FIG. 11, may perform method 1400.

Method 1400 begins at processing block 1410 where a PNID may identify, based on a computed hash value for a packet of a flow, a packet queue of a set of packet queues to route the packet. In one implementation, the set of packet queues includes a set of synchronization packet queues and a set of non-synchronization packet queues. Then, at block 1420, the PNID may reference, by a thread accessing the packet from the packet queue, a flow table using the computed hash value for the packet.

Subsequently, at block 1430, the PNID may perform, based on lookup results from referencing the flow table, perform one of adding a flow rule for the flow to the flow table, discarding the packet as a duplicate, processing the packet using the flow rule for the flow in the flow table, or dropping the packet. Lastly, at block 1440, the PNID may enforce correctness at the flow table based on a key for the packet stored in the flow table and an age context table maintaining timeout values for the key and applying an uncertainty interval to the timeout values.

The following examples pertain to further embodiments. Example 1 is an apparatus to facilitate stateful flow table management using programmable network interface devices. The apparatus of Example 1 includes a host interface; a network interface; hardware storage to store a flow table; and programmable circuitry communicably coupled to the host interface and the network interface, the programmable circuitry comprising one or more processors are to implement network interface functionality and are to: implement a hash table and an age context table, wherein the hash table and the age context table are to reference flow rules maintained in the flow table stored in the hardware storage; process a synchronization packet for a flow received at the host interface or the network interface by adding a flow rule for the flow to the flow table, adding a hash entry corresponding to the flow rule to the hash table, and adding an age context entry for the flow to the age context table; and process subsequent packets for the flow by performing a first lookup at the hash table to access the flow rule for the flow at the flow table and by performing a second lookup at the age context table to apply one or more aging rules to the flow rule in the flow table.

In Example 2, the subject matter of Example I can optionally include wherein the first lookup is to utilize a cuckoo-based hash scheme to access the flow rule at the flow table. In Example 3, the subject matter of any one of Examples 1-2 can optionally include wherein an entry for the flow rule at the flow table comprises a software flow identifier (ID) that is an index to the age context table. In Example 4, the subject matter of any one of Examples 1-3 can optionally include wherein the hash entry at the hash table comprises a key and a first timestamp, and wherein the age context entry at the age context table comprises the key, an age context state, a time select, and a second timestamp.

In Example 5, the subject matter of any one of Examples 1-4 can optionally include wherein the age context state comprises at least a valid bit and a hash table entry presence bit. In Example 6, the subject matter of any one of Examples 1-5 can optionally include wherein the time select stores a time value for the hash entry. In Example 7, the subject matter of any one of Examples 1-6 can optionally include wherein the programmable circuitry is further to scan the age context table to identify expiration of timers based on values of the time select for entries in the age context table, and is further to delete any entries having an expired timer.

In Example 8, the subject matter of any one of Examples 1-7 can optionally include wherein the flow table is stored in double data rate synchronous dynamic random access memory (DDR-SRAM) of the hardware storage. In Example 9, the subject matter of any one of Examples 1-8 can optionally include wherein the host interface, the network interface, the hardware storage, and the programmable circuitry are part of a programmable network interface device that comprises at least one of an infrastructure processing unit (IPU), data processing unit (DPU), or edge processing unit (EPU).

Example 10 is a method for facilitating stateful flow table management using programmable network interface devices. The method of Example 10 can include storing, by hardware storage of a programmable network interface device, a flow table, wherein the programmable network interface device comprises a host interface, a network interface, and programmable circuitry comprising one or more processors are to implement network interface functionality; implementing, by the programmable circuitry, a hash table and an age context table, wherein the hash table and the age context table are to reference flow rules maintained in the flow table stored in the hardware storage; processing, by the programmable circuitry, a synchronization packet for a flow received at the host interface or the network interface by adding a flow rule for the flow to the flow table, adding a hash entry corresponding to the flow rule to the hash table, and adding an age context entry for the flow to the age context table; and processing, by the programmable circuitry, subsequent packets for the flow by performing a first lookup at the hash table to access the flow rule for the flow at the flow table and by performing a second lookup at the age context table to apply one or more aging rules to the flow rule in the flow table.

In Example 11, the subject matter of Example 10 can optionally include wherein the first lookup is to utilize a cuckoo-based hash scheme to access the flow rule at the flow table. In Example 12, the subject matter of Examples 10-11 can optionally include wherein an entry for the flow rule at the flow table comprises a software flow identifier (ID) that is an index to the age context table. In Example 13, the subject matter of Examples 10-12 can optionally include wherein the hash entry at the hash table comprises a key and a first timestamp, and wherein the age context entry at the age context table comprises the key, an age context state, a time select, and a second timestamp.

In Example 14, the subject matter of Examples 10-13 can optionally include wherein the age context state comprises at least a valid bit and a hash table entry presence bit. In Example 15, the subject matter of Examples 10-14 can optionally include wherein the time select stores a timeout value for the hash entry, and wherein the programmable circuitry is further to scan the age context table to identify expiration of timers based on values of the time select for entries in the age context table, and is further to delete any entries having an expired timer.

Example 16 is a non-transitory computer-readable storage medium for facilitating stateful flow table management using programmable network interface devices. The non-transitory computer-readable storage medium of Example 16 having instructions stored thereon, which when executed by one or more processors, cause the one or more processors to perform operations comprising: storing, by hardware storage of a programmable network interface device, a flow table, wherein the programmable network interface device comprises a host interface, a network interface, and programmable circuitry comprising the one or more processors are to implement network interface functionality; implementing, by the programmable circuitry, a hash table and an age context table, wherein the hash table and the age context table are to reference flow rules maintained in the flow table stored in the hardware storage; processing, by the programmable circuitry, a synchronization packet for a flow received at the host interface or the network interface by adding a flow rule for the flow to the flow table, adding a hash entry corresponding to the flow rule to the hash table, and adding an age context entry for the flow to the age context table; and processing, by the programmable circuitry, subsequent packets for the flow by performing a first lookup at the hash table to access the flow rule for the flow at the flow table and by performing a second lookup at the age context table to apply one or more aging rules to the flow rule in the flow table.

In Example 17, the subject matter of Example 16 can optionally include wherein the first lookup is to utilize a cuckoo-based hash scheme to access the flow rule at the flow table. In Example 18, the subject matter of Examples 16-17 can optionally include wherein an entry for the flow rule at the flow table comprises a software flow identifier (ID) that is an index to the age context table. In Example 19, the subject matter of Examples 16-18 can optionally include wherein the hash entry at the hash table comprises a key and a first timestamp, wherein the age context entry at the age context table comprises the key, an age context state, a time select, and a second timestamp, and wherein the age context state comprises at least a valid bit and a hash table entry presence bit. In Example 20, the subject matter of Examples 16-19 can optionally include wherein the time select stores a timeout value for the hash entry, and wherein the programmable circuitry is further to scan the age context table to identify expiration of timers based on values of the time select for entries in the age context table, and is further to delete any entries having an expired timer.

Example 21 is a system for facilitating stateful flow table management using programmable network interface devices. The system of Example 21 can optionally include a cluster of processing units; and a programmable network interface device communicably coupled to the cluster of processing units and comprising: a host interface; a network interface; hardware storage to store a flow table; and programmable circuitry communicably coupled to the host interface and the network interface, the programmable circuitry comprising one or more processors are to implement network interface functionality and are to: implement a hash table and an age context table, wherein the hash table and the age context table are to reference flow rules maintained in the flow table stored in the hardware storage; process a synchronization packet for a flow received at the host interface or the network interface by adding a flow rule for the flow to the flow table, adding a hash entry corresponding to the flow rule to the hash table, and adding an age context entry for the flow to the age context table; and process subsequent packets for the flow by performing a first lookup at the hash table to access the flow rule for the flow at the flow table and by performing a second lookup at the age context table to apply one or more aging rules to the flow rule in the flow table.

In Example 22, the subject matter of Example 21 can optionally include wherein the first lookup is to utilize a cuckoo-based hash scheme to access the flow rule at the flow table. In Example 23, the subject matter of any one of Examples 21-22 can optionally include wherein an entry for the flow rule at the flow table comprises a software flow identifier (ID) that is an index to the age context table. In Example 24, the subject matter of any one of Examples 21-23 can optionally include wherein the hash entry at the hash table comprises a key and a first timestamp, and wherein the age context entry at the age context table comprises the key, an age context state, a time select, and a second timestamp.

In Example 25, the subject matter of any one of Examples 21-24 can optionally include wherein the age context state comprises at least a valid bit and a hash table entry presence bit. In Example 26, the subject matter of any one of Examples 21-25 can optionally include wherein the time select stores a time value for the hash entry. In Example 27, the subject matter of any one of Examples 21-26 can optionally include wherein the programmable circuitry is further to scan the age context table to identify expiration of timers based on values of the time select for entries in the age context table, and is further to delete any entries having an expired timer.

In Example 28, the subject matter of any one of Examples 21-27 can optionally include wherein the flow table is stored in double data rate synchronous dynamic random access memory (DDR-SRAM) of the hardware storage. In Example 29, the subject matter of any one of Examples 21-28 can optionally include wherein the host interface, the network interface, the hardware storage, and the programmable circuitry are part of a programmable network interface device that comprises at least one of an infrastructure processing unit (IPU), data processing unit (DPU), or edge processing unit (EPU).

Example 30 is an apparatus for facilitating stateful flow table management using programmable network interface devices, comprising means for storing, using hardware storage of a programmable network interface device, a flow table, wherein the programmable network interface device comprises a host interface, a network interface, and programmable circuitry comprising one or more processors are to implement network interface functionality; means for implementing, via the programmable circuitry, a hash table and an age context table, wherein the hash table and the age context table are to reference flow rules maintained in the flow table stored in the hardware storage; means for processing, via the programmable circuitry, a synchronization packet for a flow received at the host interface or the network interface by adding a flow rule for the flow to the flow table, adding a hash entry corresponding to the flow rule to the hash table, and adding an age context entry for the flow to the age context table; and means for processing, via the programmable circuitry, subsequent packets for the flow by performing a first lookup at the hash table to access the flow rule for the flow at the flow table and by performing a second lookup at the age context table to apply one or more aging rules to the flow rule in the flow table. In Example 31, the subject matter of Example 30 can optionally include the apparatus further configured to perform the method of any one of the Examples 11 to 15.

Example 32 is at least one machine readable medium comprising a plurality of instructions that in response to being executed on a computing device, cause the computing device to carry out a method according to any one of Examples 10 to 15. Example 33 is an apparatus for facilitating stateful flow table management using programmable network interface devices, configured to perform the method of any one of Examples 10 to 15. Example 34 is an apparatus for stateful flow table management using programmable network interface devices, comprising means for performing the method of any one of Examples 10 to 15. Specifics in the Examples may be used anywhere in one or more embodiments.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. An apparatus comprising:
a host interface;
a network interface;
hardware storage to store a flow table; and
programmable circuitry communicably coupled to the host interface and the network interface, the programmable circuitry comprising one or more processors are to implement network interface functionality and are to:
implement a hash table and an age context table, wherein the hash table and the age context table are to reference flow rules maintained in the flow table stored in the hardware storage;
process a synchronization packet for a flow received at the host interface or the network interface by adding a flow rule for the flow to the flow table, adding a hash entry corresponding to the flow rule to the hash table, and adding an age context entry for the flow to the age context table; and
process subsequent packets for the flow by performing a first lookup at the hash table to access the flow rule for the flow at the flow table and by performing a second lookup at the age context table to apply one or more aging rules to the flow rule in the flow table.

2. The apparatus of claim 1, wherein the first lookup is to utilize a cuckoo-based hash scheme to access the flow rule at the flow table.

3. The apparatus of claim 1, wherein an entry for the flow rule at the flow table comprises a software flow identifier (ID) that is an index to the age context table.

4. The apparatus of claim 3, wherein the hash entry at the hash table comprises a key and a first timestamp, and wherein the age context entry at the age context table comprises the key, an age context state, a time select, and a second timestamp.

5. The apparatus of claim 4, wherein the age context state comprises at least a valid bit and a hash table entry presence bit.

6. The apparatus of claim 5, wherein the time select stores a time value for the hash entry.

7. The apparatus of claim 6, wherein the programmable circuitry is further to scan the age context table to identify expiration of timers based on values of the time select for entries in the age context table, and is further to delete any entries having an expired timer.

8. The apparatus of claim 1, wherein the flow table is stored in double data rate synchronous dynamic random access memory (DDR-SRAM) of the hardware storage.

9. The apparatus of claim 1, wherein the host interface, the network interface, the hardware storage, and the programmable circuitry are part of a programmable network interface device that comprises at least one of an infrastructure processing unit (IPU), data processing unit (DPU), or edge processing unit (EPU).

10. A method comprising:
storing, by hardware storage of a programmable network interface device, a flow table, wherein the programmable network interface device comprises a host interface, a network interface, and programmable circuitry comprising one or more processors are to implement network interface functionality;
implementing, by the programmable circuitry, a hash table and an age context table, wherein the hash table and the age context table are to reference flow rules maintained in the flow table stored in the hardware storage;
processing, by the programmable circuitry, a synchronization packet for a flow received at the host interface or the network interface by adding a flow rule for the flow to the flow table, adding a hash entry corresponding to the flow rule to the hash table, and adding an age context entry for the flow to the age context table; and
processing, by the programmable circuitry, subsequent packets for the flow by performing a first lookup at the hash table to access the flow rule for the flow at the flow table and by performing a second lookup at the age context table to apply one or more aging rules to the flow rule in the flow table.

11. The method of claim 10, wherein the first lookup is to utilize a cuckoo-based hash scheme to access the flow rule at the flow table.

12. The method of claim 10, wherein an entry for the flow rule at the flow table comprises a software flow identifier (ID) that is an index to the age context table.

13. The method of claim 12, wherein the hash entry at the hash table comprises a key and a first timestamp, and wherein the age context entry at the age context table comprises the key, an age context state, a time select, and a second timestamp.

14. The method of claim 13, wherein the age context state comprises at least a valid bit and a hash table entry presence bit.

15. The method of claim 14, wherein the time select stores a timeout value for the hash entry, and wherein the programmable circuitry is further to scan the age context table to identify expiration of timers based on values of the time select for entries in the age context table, and is further to delete any entries having an expired timer.

16. A non-transitory computer-readable medium having instructions stored thereon, which when executed by one or more processors, cause the one or more processors to perform operations comprising:
storing, by hardware storage of a programmable network interface device, a flow table, wherein the programmable network interface device comprises a host interface, a network interface, and programmable circuitry comprising the one or more processors are to implement network interface functionality;
implementing, by the programmable circuitry, a hash table and an age context table, wherein the hash table and the age context table are to reference flow rules maintained in the flow table stored in the hardware storage;
processing, by the programmable circuitry, a synchronization packet for a flow received at the host interface or the network interface by adding a flow rule for the flow to the flow table, adding a hash entry corresponding to the flow rule to the hash table, and adding an age context entry for the flow to the age context table; and
processing, by the programmable circuitry, subsequent packets for the flow by performing a first lookup at the hash table to access the flow rule for the flow at the flow table and by performing a second lookup at the age context table to apply one or more aging rules to the flow rule in the flow table.

17. The non-transitory computer-readable medium of claim 16, wherein the first lookup is to utilize a cuckoo-based hash scheme to access the flow rule at the flow table.

18. The non-transitory computer-readable medium of claim 16, wherein an entry for the flow rule at the flow table comprises a software flow identifier (ID) that is an index to the age context table.

19. The non-transitory computer-readable medium of claim 18, wherein the hash entry at the hash table comprises a key and a first timestamp, wherein the age context entry at the age context table comprises the key, an age context state, a time select, and a second timestamp, and wherein the age context state comprises at least a valid bit and a hash table entry presence bit.

20. The non-transitory computer-readable medium of claim 19, wherein the time select stores a timeout value for the hash entry, and wherein the programmable circuitry is further to scan the age context table to identify expiration of timers based on values of the time select for entries in the age context table, and is further to delete any entries having an expired timer.
